(19) United States
(12) Patent Application Publication
(10) Pub. No.: US 2026/0203923 A1
(43) Pub. Date: Jul. 16, 2026

(54) MONOCULAR DEPTH AND OPTICAL FLOW ESTIMATION USING DIFFUSION MODELS

(71) Applicant: GOOGLE LLC, Mountain View, CA (US)

(72) Inventors: Saurabh SAXENA, Ontario (CA); Mohammad NOROUZI, Toronto (CA); David James FLEET, Toronto (CA); Abhishek KAR, Fremont, CA (US); Charles Irwin HERRMANN, Boston, MA (US); Junhwa HUR, Cambridge, MA (US); Deqing SUN, Cambridge, MA (US)

(21) Appl. No.: 19/150,801

(22) PCT Filed: Jan. 26, 2024
(86) PCT No.: PCT/US2024/013078

§ 371 Date: Jul. 24, 2025

Related U.S. Application Data
(60) Provisional application No. 63/481,970, filed on Jan. 27, 2023.
(60) Provisional application No. 63/502,485, filed on May 16, 2023.
(60) Provisional application No. 63/505,476, filed on Jun. 1, 2023.
(60) Provisional application No. 63/603,306, filed on Nov. 28, 2023.

(51) Int. Cl. G06T 7/55; G06N 3/08; G06T 3/40; G06T 5/77

(52) U.S. Cl. CPC G06T 7/55; G06N 3/08; G06T 3/40; G06T 5/77; G06T 2207/10024; G06T 2207/10028; G06T 2207/20081; G06T 2207/20132

(57) ABSTRACT

Improved methods are provided for generating, via a noise-diffusion iterative process, depth maps or optical flow maps from input images. Also provided are improved methods for training the machine learning model(s) employed in the iterative process and for augmenting die set of training data used to train such models. By translating the depth or optical flow map prediction process into the noise diffusion context, improved performance with respect to compute cost, training data, requirements, model size, and output quality are obtained. Additionally, the noise diffusion context allows models trained as described herein to generate maps de novo from target color images and/or to begin from initial ‘guess’ maps (e.g., noisy maps, maps containing holes) when generating improved output maps, natively incorporating the imperfect prior information represented by such initial maps.

### CROSS-REFERENCE TO RELATED APPLICATION

This application claims priority to U.S. Provisional Patent Application No. 63/481,970, filed on Jan. 27, 2023, to U.S. Provisional Patent Application No. 63/502,485, filed on May 16, 2023, to U.S. Provisional Patent Application No. 63/505,476, filed on Jun. 1, 2023, and to U.S. Provisional Patent Application No. 63/603,306, filed on Nov. 28, 2023, the contents of which are hereby incorporated by reference in their entirety.

### BACKGROUND

Depth maps representing the distance from a reference location (e.g., to a lidar sensor, to a time-of-flight sensor, to a camera) to points in an environment can be beneficial in a variety of mapping, navigation, or other applications. For example, such depth maps can be used by a robot to navigate an environment and to interact with objects therein. Current depth sensors are generally expensive and/or generate low-quality depth information (e.g., noisy depth information, depth information containing holes or other artifacts). Images (e.g., color images) of environments contain information about the depth of objects therein, and can be used to predict depth information and/or to augment depth information generated by depth sensors associated with (e.g., collocated with and oriented parallel thereto) cameras used to generate such images.

Optical flow maps represent the motion of corresponding pixels between pairs of images. Optical flow maps can be used in a variety of applications, e.g., video compression, object detection and/or avoidance, navigation, or other applications. Optical flow maps can be generated using heuristic algorithms and/or trained machine learning models. However, current methods for optical flow map estimation can exhibit a variety of shortcomings, including high computational cost, difficulty predicting the motion of small features of the image(s), difficulty resolving ambiguous motions (e.g., the motion of multiple similar objects within a single scene), difficulty predicting the motion of poorly-focused features of the image(s), and other shortcomings.

### SUMMARY

In a first aspect, a computer-implemented method is provided that includes: training a machine learning model to predict depth maps for color images via an iterative diffusion inference process, wherein training the machine learning model includes: (i) adding noise to a first depth map to generate a second depth map, wherein the first depth map represents depth across a first scene depicted in a first color image; (ii) applying the first color image and the second depth map to the machine learning model to generate a third depth map; (iii) based on the third depth map, generating a plurality of loss values; and (iv) updating the machine learning model based on the plurality of loss values.

In a second aspect, a computer-implemented method is provided that includes using a machine learning model to predict a first target depth map for a target color image via an iterative diffusion inference process by, for a plurality of iterations: applying the target color image and a respective input depth map estimate to the machine learning model to generate a respective output depth map, wherein the input depth map of a first iteration of the plurality of iterations is a randomly or pseudo-randomly generated depth map of noise, wherein the input depth map for each iteration of the plurality of iterations other than the first iteration is the output depth map of an immediately preceding iteration with an amount of noise added thereto, and wherein the first target depth map is the output depth map of a final iteration of the plurality of iterations.

In a third aspect, a computer-implemented method is provided that includes training a machine learning model to predict optical flow maps for pairs of color images via an iterative diffusion inference process, wherein training the machine learning model includes: (i) adding noise to a first optical flow map to generate a second optical flow map, wherein the first optical flow map represents optical flow from a first color image of a scene to a second color image of the scene; (ii) applying the first color image, the second color image and the second optical flow map to the machine learning model to generate a third optical flow map; (iii) based on the third optical flow map, generating a plurality of loss values; and (iv) updating the machine learning model based on the plurality of loss values

In a fourth aspect, a computer-implemented method is provided that includes using a machine learning model to predict a first target optical flow map for a target pair of color images via an iterative diffusion inference process by, for a plurality of iterations: applying the target pair of color images and a respective input optical flow map estimate to the machine learning model to generate a respective output optical flow map, wherein the input optical flow map of a first iteration of the plurality of iterations is a randomly or pseudo-randomly generated optical flow map of noise, wherein the input optical flow map for each iteration of the plurality of iterations other than the first iteration is the output optical flow map of an immediately preceding iteration with an amount of noise added thereto, and wherein the first target optical flow map is the output optical flow map of a final iteration of the plurality of iterations.

In a fifth aspect, a non-transitory computer readable medium is provided having stored therein instructions executable by a computing device to cause the computing device to perform the method of the first, second, third, or fourth aspects.

In a sixth aspect, a system is provided that includes: (i) a controller comprising one or more processors; and (ii) a non-transitory computer readable medium having stored therein instructions executable by the controller device to cause the one or more processors to perform the method of the first, second, third, or fourth aspects.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1A illustrates aspects of an example inference process, according to example embodiments.

FIG. 1A illustrates aspects of an example training process, according to example embodiments.

FIG. 2 illustrates aspects of an example system.

FIG. 3 illustrates aspects of an example process.

FIG. 4A illustrates a flowchart of an example method.

FIG. 4B illustrates a flowchart of an example method.

FIG. 4C illustrates a flowchart of an example method.

FIG. 4D illustrates a flowchart of an example method.

FIG. 5 illustrates aspects of an experimental method.

FIG. 6 illustrates experimental results.

FIG. 7 illustrates experimental results.

FIG. 8 illustrates experimental results.

FIG. 9 illustrates aspects of an experimental method.

FIG. 10 illustrates experimental results.

FIG. 11 illustrates aspects of an experimental method.

FIG. 12 illustrates experimental results.

FIG. 13 illustrates experimental results.

FIG. 14 illustrates experimental results.

FIG. 15 illustrates experimental results.

FIG. 16 illustrates aspects of an experimental method.

FIG. 17 illustrates experimental results.

FIG. 18 illustrates experimental results.

FIG. 19 illustrates experimental results.

FIG. 20 illustrates experimental results.

FIG. 21 illustrates experimental results.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

### I. Overview

It is desirable in a variety of applications to obtain depth map information for an environment (e.g., for a scene depicted in a single color image) and/or estimates of optical flow between pairs of images (e.g., to estimate which portions of an image and/or objects depicted therein are moving, in what direction, and to what degree). However, it can be difficult to obtain such information, or to obtain such information to a desired level of quality. This can be related to the absence of depth sensor elements (e.g., lidar, radar, time-of-flight sensors, ultrasound sensors), the presence of low-quality depth sensor elements, the scene having been generated artificially (e.g., as an image output from a generative network), ambiguity or other difficulties in generating optical flow estimates from a pair of images, or some other factor or condition. Where a single image (e.g., a color image) of the scene is available, it is desirable to be able to predict the depth map from the single color image. However, existing models trained to generate such estimates, or to estimate optical flow from pairs of such color images, are computationally expensive to execute and expensive to license. It is also difficult to generate novel predictive models, as the available training data (e.g., pairs of depth maps and images that depict the same scene, triplets of images of a scene and optical flow maps therebetween) is limited and often low-quality (e.g., contains holes, contains noise).

The machine learning models and methods for training such provided herein exhibit a variety of improvements relative to prior models and training methods:
Ability to achieve improved accuracy when trained on smaller datasets;
Ability to achieve improved accuracy when trained on lower-quality datasets (e.g., noisy depth or optical flow maps, depth or optical flow maps with holes);
Ability to represent multi-modal/ambiguous depth or optical flow regions (e.g., windows, mirrors) by, e.g., generating multiple depth or optical flow maps for a input that may then differ significantly in the multi-modal region(s);
Ability to refine noisy or incomplete depth or optical flow maps, even without having been explicitly trained on such a task.

The machine learning models described herein can be applied to a variety of applications:
Mapping an environment based on a single image of the environment (e.g., in order to navigate the environment, to localize people or objects in the environment, to manipulate objects in the environment);
Filling in holes in depth maps using associated images (e.g., to augment depth map information generated by a depth sensor by using images generated by a camera that is collocated with and/or a part of the depth sensor and that is directed in the same direction as the depth sensor);
Generating geometric information for scenes represented in images created by generative networks;
Generating images/depth maps for wholly simulated environments (e.g., environments ‘hallucinated’ by a generative network) in a manner that permits stabilization of the geometry of the simulated environment;
Identifying objects in a scene and/or quantifying the direction and degree of motion of such objects based on pairs of images of the scene.

The machine learning models described herein are trained to be used within a generative noise diffusion context, with outputs generated via an iterative diffusion inference process. Such a process results in an output depth map that is conditioned on an input image or pair of input images (e.g., a color image, like an RGB image, a YUV image, a hyperspectral image having more or fewer than three color channels). Each iteration of the iterative diffusion inference process includes adding noise to the depth map output of the previous iteration and applying the noise-added previous output, along with the input image, to the machine learning model to generate a refined depth or optical flow map output. The amount of noise added in each iteration can change according to a pre-specified noise schedule, with the amount of added noise generally reducing from the initial iterations to the final iterations.

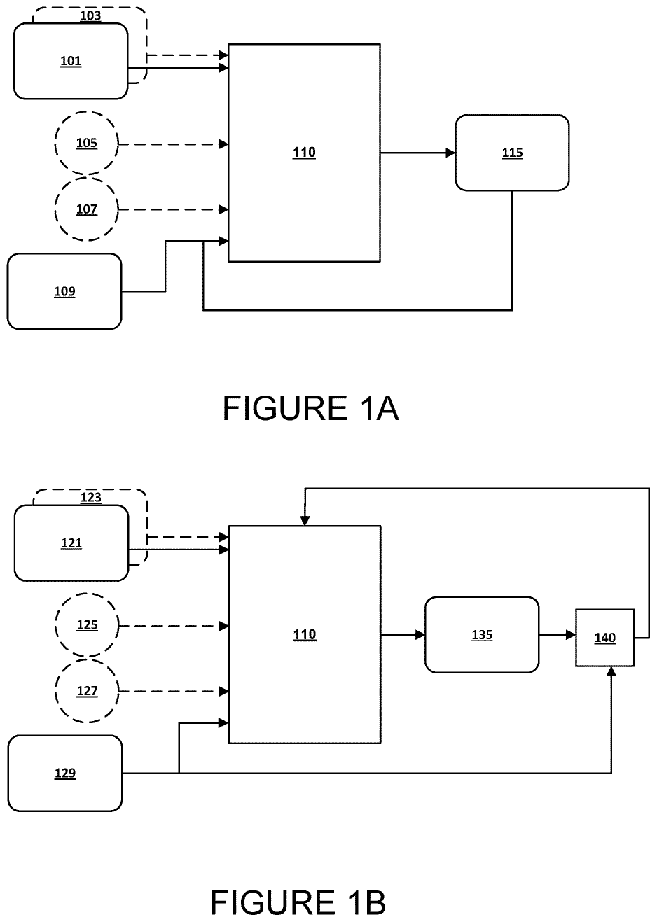

FIG. 1A depicts the use of a machine learning model 110 as described herein to generate, from input color image(s) 101 (/103), via an iterative diffusion inference process, an output depth or optical flow map 115 therefor. A single input color image 101 is applied as an input to the model 110 to generate an output depth map 115 therefor that represents depth across a scene depicted in the input color image 101, while an input pair of color images (a first color image 101 and a second color image 103) are applied as inputs to the model 110 to generate an output optical flow map 115 therefor that represents optical flow from the first color image 101 of a scene to the second color image 103 of the scene. For each iteration of the iterative diffusion inference process, an input noisy depth or optical flow map is also applied as an input to the model 110. For the first iteration of the process, this input is an initial map 109, and for subsequent iterations, the map input is the map output 115 from the prior iteration with an amount of noise added thereto. The magnitude of such added noise may be determined according to a noise schedule that changes with the iterations of the iterative process, e.g., according to a noise schedule that monotonically decreases for later iterations of the process.

Additional optional inputs may be provided. For example, a field of view measurement 105, which represents an angular field of view of the input color image 101, could be provided in order to, e.g., facilitate the generation of metrically-accurate, quantitative output depth maps 115 for the input color image 101. The model 110 could be trained to accept such an additional field of view measurement 105 input as described elsewhere herein, e.g., to accept a field of view measurement 105 that represents a tangent function of the angular field of view (e.g., tan/2) across at least one dimension of the input color image 101.

In some examples, a noise estimate 107, which represents an expected magnitude of noise present in the input map 109/115, could be provided as an input to allow the model 110 to adjust the output map 115 in a manner that is sensitive to how ‘complete’ the iterative process is (e.g., to generate an output map 115 that is a slightly modified, ‘fine-tuned’ version of the input map for later iterations of the process, while introducing larger modifications to the input map for earlier iterations). Such a noise estimate 107 could be determined according to a noise schedule that is dependent on the iterations of the process, e.g., that monotonically decreases as a function of increasing iteration number. The model 110 could be trained to accept such an additional noise estimate 107 input as described elsewhere herein, e.g., to generate an output depth map 115 that represents a weighted combination of (i) the estimated noise in the input map and (ii) the estimated ‘signal’ in the input map, with the proportion of the weighting determined by the noise estimate 107 input (e.g., the model 110 could be trained to output maps that are “V-parameterized,” rather than being “X-parameterized” to output an estimate of the ‘signal’ alone in the input or being “s-parameterized” to output an estimate of the ‘noise’ alone in the input.

The initial input map 109 could be a ‘pure noise’ map(generated via a random or pseudo-random noise generation process) in applications where no corresponding depth or optical map information or estimate is available for the input image(s). Where depth information is available for the input image(s) (e.g., a noisy depth map, a noisy optical flow map, a low-resolution optical flow map, an optical flow map that only represents regions of optical flow that have been determined with more than a specified degree of confidence, a depth map that contains one or more holes), such an initial estimate map, with noise added thereto, could be used as the initial input map 109. This allows machine learning models as described herein to be used in naïve inference (i.e., where no depth or optical flow information is available for an input image or image pair) or to augment or otherwise improve imperfect depth or optical flow information (e.g., hole filling, denoising, upsampling, initial estimate refinement).

Note that a depth or optical flow map output from a machine learning model as described herein (e.g., map 115 output from model 110) could represent depth or optical flow information in a variety of ways. For example, the output map could represent an estimate of the ‘true’ depth or optical flow map for the input image(s); a model trained to operate in such a manner may be described as being “X-parameterized.” In another example, the output map could represent an estimate of the ‘noise’ present in the depth or optical flow map input to the model; a model trained to operate in such a manner may be described as being “8-parameterized.” In yet another example, the output map could represent a weighted combination of (i) an estimate of the ‘noise’ present in the depth or optical flow map input to the model and (ii) an estimate of the ‘true’ depth or optical flow map for the input image(s), with the weighting set by an auxiliary input to the model; a model trained to operate in such a manner may be described as being “V-parameterized.” The iterative process above may be modified according to the type of output generated by the model. For example, where the model outputs an estimate of the noise in the input noisy map(the model is “ε-parameterized”), the n+1th noisy map input to the model could be the nth input map with the nth model output subtracted therefrom (to obtain an estimate of the ‘true’ map for the input color image(s)), and then some amount of noise added thereto. Other inter-iteration computations, and terminal computations to obtain a ‘final’ output depth or optical flow map for input color image(s) based on the final-iteration model output, can be implemented for “X-parameterized” or “V-parameterized” machine learning models.

FIG. 1B depicts aspects of a training method to train a machine learning model as described herein (e.g., to train model 110). This training method includes applying input color image(s) 121 (/123), along with an input noisy depth or optical flow map 129, to the model 110 being trained, along with any optional additional inputs (e.g., a field of view measurement 125 that represents an angular field of view of the input color image 121, a noise estimate 127 that represents a magnitude of noise present in the input map 129), to generate an output depth or optical flow map 135. Loss values are determined 140 by comparing the output map 135 to information about the input map 129 to determine loss values that are then used (e.g., by backpropagation) to update the model 110.

The method used to determine 140 the loss values can depend on the intended form of the output of the model (e.g., an estimate of the true depth or optical flow map, an estimate of the noise in the input map, an input-specified weighted combination of the two). For example, for a model 110 trained to output an estimate of the ‘true’ map for the input image(s), pixelwise differences (e.g., L1 differences) between the output map 135 and the ‘true’ map used to determine the input map 129 could be determined. In another example, for a model 110 trained to output an estimate of the ‘noise’ present in the input map 129, pixelwise differences (e.g., L1 differences) between the output map 135 and the ‘noise’ added to the ‘true’ map in order to determine the input map 129 could be determined. In yet another example, for a model 110 trained to output a map that is a weighted combination of the ‘noise’ and the ‘signal’ present in the input noisy map, the “target” output map(i.e., a map that corresponds to the specified weighted combination of the ‘noise’ and the ‘signal’ in the input noisy map) could be determined and pixelwise differences (e.g., L1 differences) between the output map 135 and the determined target map determined. Additionally, where the training data is incomplete (e.g., where an input depth map 129 includes holes or other imperfections), the loss values (e.g., pixelwise differences between the output map 135 and the input map 129 or information related thereto) could be determined only based on the portions of the training that were ‘true,’ e.g., only based on the non-hole portions of an input depth map that includes one or more holes.

As shown by the experimental results below, the use of L1 loss values between the model output maps and corresponding ‘target’ maps for training provides benefits with respect to model accuracy, speed of training, and amount of training data needed. Additionally, determination of L1 loss values is less computationally expensive than determining L2 loss values.

The experimental results below also show the benefits of “V-parameterized” models for the applications depicted herein. Such “V-parameterized” models, employed in the iterative diffusion inference process described herein, result in the determination of high-accuracy depth or optical flow map estimates from input color image(s) using significantly fewer iterations of the iterative diffusion inference process. This facilitates significant savings with respect to computational cost when using such models to estimate such depth and/or optical flow maps.

As noted above, the model of an iterative diffusion inference process as described herein may be conditioned on a field of view measurement that represents an angular field of view of an input color image on which the model is also conditioned, in order to estimate a depth map for the input color image. Such a field of view measurement could be obtained based on, e.g., the field of view of an image sensor used to generate the color image. Alternatively, the field of view measurement could be determined from the input color image, e.g., by applying the input color image to a model trained to estimate the field of view of input images. Providing such a measurement of the field of view of the input image can allow the model to generate higher-quality (e.g., more accurate) depth map estimates. Additionally, providing the field of view measurement can allow the model to output metric depth maps that quantitatively represent the depth across the input color image, allowing such metric depth maps to be used directly for, e.g., navigation or other applications that include determining the distance from a camera or other image sensor to contents of an environment thereof. The field of view measurement could be provided as a tangent function of the angular field of view across at least one dimension of the input color image (e.g., tan/2 of the angular field of view across the input color image); this could facilitate the model learning how to use the additional field of view information with fewer training steps and/or using fewer training data examples, since such tangent functions may more ‘natively’ represent the relationship between changes in the angular field of view of images and corresponding changes in the metric depth of objects depicted therein.

Training datasets that include color images field of view annotations are rarer and higher cost relative to color image training datasets that lack such data. Accordingly, a model as described herein could be pre-trained (e.g., to output estimates of the noise and/or signal in an input noisy depth or optical flow map conditioned on input color image(s)) using a dataset that lacks such field of view annotation but that is relatively larger than available training datasets including such information. Once this pre-training is completed, the pre-trained model could be modified to accept field of view measurements and further trained using images and associated training data that includes field of view measurements therefor. In this way, an accurate model can be trained to condition on field of view measurements while using a significantly reduced number of training examples that include such field of view measurement information. Modifying such a pre-trained model to accept field of view measurements could include, e.g., projecting the input field of view measurement via a sinusoidal positional embedding. The result of the sinusoidal positional embedding could then be provided as inputs to the various layers of the pre-trained model, e.g., via a newly-added set of weights or other linear projection of outputs of the sinusoidal positional embedding to one or more layers of the pre-trained model.

Additionally or alternatively, model training could be improved by augmenting an existing training dataset that includes field of view measurements to include a wider variety of field of view measurements. This could be done by cropping or uncropping images of the training dataset and modifying the corresponding field of view measurements to account for the degree of cropping/uncropping. Where the image is uncropped, a variety of methods could be used to determine the ‘novel’ uncropped portions of the image. This could include, e.g., applying the source image to a model trained to uncrop images. In another example, the ‘novel’ portions of an uncropped image could simply be populated with randomly or pseudo-randomly generated noise content (e.g., Gaussian red, green, and blue pixel magnitude data). As shown by the experimental data related below, such a ‘random fill’ image uncropping method was able to generate models of similar quality, and in similar or fewer training steps, than the use of generative models to uncrop images, resulting in significant computational cost savings. When updating a model using such uncropped data, the loss values determined therefor could be limited to the ‘source’ portions of the training image and/or corresponding portions of the depth or optical flow map(and not based on any ‘hallucinated’ or ‘noisy’ uncropped portions of the input color image).

The iterative diffusion inference process could be used in a ‘coarse to fine’ manner to generate high-resolution depth and/or optical flow maps for input color image(s). For example, the iterative diffusion inference process could be performed a first time, based on the entirety of an input color image or color image pair, to generate a first, lower-resolution estimated depth or optical flow map for the input color image or image pair. This low-resolution estimate could then be upsampled and divided into patches. The conditioning input color image, or pair of images, could also be divided into a corresponding set of patches, with each patch of the input color image(s) corresponding in extent to the corresponding patch of the low-resolution depth or optical flow map. The iterative diffusion inference process could then be repeated for each associated set of patches of the input image(s) and the low-resolution map to generate respective patches of a high-resolution estimate of the depth or optical flow map for the original, complete input color image(s). The high-resolution estimate could then be generated by stitching each of the high-resolution patches together. This could include applying the high-resolution patches to a mask such that areas of the combined high-resolution estimate near the patch boundaries represent a weighted combination of corresponding neighboring high-resolution patches, so as tho reduce artifacts at the boundaries between the patches in the combined high-resolution estimate depth or optical flow map.

The machine learning models used to generate the initial low-resolution depth or optical flow map and to generate the various high-resolution patches of the high-resolution combined depth or optical flow map could be the same model or different models (e.g., a first model specifically trained to generate low-resolution depth or optical flow maps and a second model specifically trained to generate high-resolution depth or optical flow maps). Such a two-stage map generation process, with a first use of the iterative diffusion inference process used to generate a low-resolution estimate of the depth or optical flow map, and then a second set of uses of the iterative diffusion inference process used to generate respective patches of a high-resolution estimate of the depth or optical flow map, starting from respective initial depth or optical flow estimates that are respective patches of the upsampled low-resolution estimate, can provide a variety of benefits. For example, the model(s) used to effect such a scheme, since they output relatively smaller-resolution outputs, can be implemented for a specified accuracy in fewer parameters, leading to decreased storage requirements and reduced memory requirements for execution.

A machine learning model as described herein could be trained to predict, as part of the iterative diffusion inference process described herein, depth maps for input color images of indoor and/or outdoor scenes. For example, a first model could be trained, using a training dataset of images of indoor scenes and depth maps therefor, to predict depth maps having values between 0 and 10 meters for color images of indoor scenes; a second model could be trained, using a training dataset of images of outdoor scenes and depth maps therefor, to predict depth maps having values greater than 10 meters (e.g., between 10 and 80 meters) for color images of outdoor scenes. A target color image could be accompanied by a label indicating whether it depicts an indoor scene or an outdoor scene, and/or the image could be applied to a model trained to identify whether an indoor scene or an outdoor scene is represented, and the target color image then applied to the appropriate one of the first or second images to determine a target depth map therefor.

Such a two-(or more-) model scheme implicates additional cost in terms of training, training data, model storage, and other costs. However, it can be difficult to train a single model to predict depth maps for both indoor and outdoor scenes, or for some other sets of images that differ a great deal with respect to the depths of objects depicted therein. The embodiments described herein provide improved models, and improved methods of training thereof, that can receive input color images and, via the iterative diffusion inference process described herein, generate estimated depth maps therefor whether the input image depicts an indoor scene, an outdoor scene, or a scene that includes both indoor and outdoor elements. The is accomplished in part by training the model to output log-distance depth maps, which represent the logarithm of depth across the scene depicted in the input color image. This is accomplished, in part, by converting the depth information of a training dataset into a logarithmic space. This can be accomplished by determining the logarithm of the depth information of the training dataset, and then shifting and/or scaling the logarithm of the depth information to correspond to a desired, finite range, e.g., a range from −1 to +1 or some other range of values that is symmetric about 0. A truncation step could also be applied to ensure that the shifted and scaled logarithm data remains within the desired bounded range, thereby discarding high-(or low-) value depth data, which is more likely to represent sensor artifacts or other erroneous or otherwise unwanted data.

Using logarithmic depth data to train a model to predict logarithmic depth map outputs allows those outputs to be, as evidenced by the experimental data below, metric log-distance depth maps. That is, log-distance depth maps generated as described herein can be used to determine (e.g., by scaling, shifting, and exponentiating the output log-distance depth maps) the objective depth to objects in the scene depicted by an input color image, rather than merely a depth map depicting the pattern of relative depths across the scene. Thus, models as described herein (and depth maps determined therefrom) can be used directly to map and/or navigate an environment using only a camera or other low-cost sensor that is sufficient to generate color images.

The use of a machine learning model in such a generative diffusion context provides some of the benefits and advantages of such a model as described herein. However, it is difficult to obtain and/or generate sufficient training data (e.g., color images and high-quality depth maps therefor, pairs of color images and accurate, unambiguous, high-resolution optical flow maps therefor) to train such models. Accordingly, additional improvements can be provided by performing a pre-training process using sets of available images (e.g., color images) to pre-train such models. The pre-trained model is then trained on the depth and/or optical flow map predictive task using sets of input images and corresponding depth maps and/or sets of pairs of input images and corresponding optical flow maps therefor. This pre-training process includes training the machine learning model on image-to-image predictive tasks, with a degraded version of a training image being provided to the image input of the model (the input on which the output is conditioned) and a noisy version of the training image being provided to what will become the depth or optical flow map input of the model. The model is then trained, during this pre-training phase, to recover the training image based on the degraded version of the training image as ‘input.’ This allows the model to learn general information about the structure of input images or image pairs based on a much larger training dataset than would be available if it was required that each image had corresponding depth or optical flow map information available. The set of image degradations applied could include at least one example of cropping, decoloration (i.e., the removal of color information from a color image, e.g., rendering the color image in black and white), addition of JPEG or other compression artifacts, and adding one or more holes by blanking or otherwise removing pixels of a training image.

Once pre-trained in this manner, the model can then be used as a starting state for training the model to predict depth or optical flow map outputs from input images or image pairs. Since the above pre-training process includes accepting a multi-channel noisy color image input (e.g., three input channels) and generating a multi-channel color image output (e.g., three output channels), in addition to multi-channel input(s) for the input image(s) on which the output is conditioned (e.g., three or six input channels, for depth or optical flow prediction pre-training, respectively), modifying the pre-trained model for continued training on the depth or optical flow map prediction task can include removing one or more input kernels for the noisy image input and one or more output kernels for the predicted image output and replacing them with sing1e-(for depth map prediction) or doub1e-(for optical flow map prediction, e.g., as angle of flow and distance, or as orthogonal first and second distances of flow) channel input and output kernels for receiving input noisy depth or optical flow map information and generating depth or optical flow map output predictions. This can include initializing the added single-or double-channel kernels with random weights.

In practice, depth or optical flow map information in available training datasets often includes holes, i.e., regions where depth information was not available (e.g., due to limitations of the sensor, due to the depth being out of limit, due to the depth measurement being too noisy) or where optical flow information was not available (e.g., due to ambiguity or blurring). In order to provide some of the improvements described herein, holes in such training depth maps can be filled in. This could include applying a trained model to predict, from the remainder of the depth or optical flow map, what the depth or optical flow values within the hole should be. Additionally or alternatively, a nearest-neighbors approach could be used to fill in such holes (e.g., a given pixel or other location within a hole could be assigned the depth value or optical flow angle and distance values of the nearest non-hole pixel or other location of the depth or optical flow map). Additionally or alternatively, an image (e.g., a color image) associated with a depth map could be used to determine the location and extent of the sky within in the image, and thus within the depth map, and pixels within the determined location and extent of the sky could be set to a default ‘sky’ depth value (e.g., a maximum depth value). When using such depth or optical flow map training data (i.e., depth or optical flow maps that have had one or more holes filled in), loss values or other information used to update the model being trained could be determined and/or used only for portions of the depth or optical flow map training data that correspond to ‘true,’ non-filled portions of the depth map training data (e.g., only for pixels of a training depth or optical flow map that were originally set, and thus were not ‘filled in’ with potentially erroneous depth values).

Such hole-filling processes act, functionally, to attempt to match the distribution of the input data at training time (i.e., the distribution of the depth or optical flow maps in the training data) to the distribution of the input data at inference time. However, at training time, the input data is likely to exhibit longer tails, more ‘holes,’ and other characteristics related to limitations of, e.g., depth sensors used to generate depth map training data. In contrast, at inference time, the input data is likely to be ‘pure’ noise, or generally the shorter-tailed distribution present in the output of the model from iteration to iteration of the iterative diffusion inference process described herein. To further account for this distribution shift from training to inference, another training method (which may be referred to as “unbiased conditioning” or “step-unrolled denoising” elsewhere herein) may be employed in addition to or as an alternative to the hole-filling or other training dataset improvement techniques described herein. This improvement for training machine learning models includes using the model being trained to provide an initial, improved prediction of the input depth or optical flow map training example. This improved prediction then has noise added thereto and is provided to the machine learning model again in order to generate a second output predicted depth map. Loss values or other information used to update the model (e.g., L1 loss values determined between the ‘true’ input map and the output predicted map, or between the noise added to the ‘true’ input map to generate the input map and the output predicted map, or L1 loss values determined to train a model according to V-parameterization) could then be determined based on this second output, rather than on the initial output.

Such a process can be referred to as ‘unbiased conditioning’ or ‘step-unrolled denoising,’ and can provide for improved model performance using fewer, lower-quality training examples by, e.g., reducing the bias of the model being trained between training-phase examples and inference-phase examples. Such an ‘unbiased conditioning’ training enhancement could be used only once the model being trained has been updated some amount, e.g., a specified number of training iterations, a specified increase in model performance, model performance exceeding a threshold, etc. Additionally or alternatively, such an ‘unbiased conditioning’ training enhancement could be reserved for specified discrete phases of model training, e.g., only for specific training on task-specific training examples, and not for preceding training on generic training examples.

A model as described herein could be configured in a variety of ways. For example, such a model could comport with the Efficient U-Net architecture or some other version of the U-Net architecture. For example, a model as described herein could be the Efficient U-Net architecture with the text cross attention layers removed and the self-attention layer retained. For the depth map prediction task, the architecture could be modified to have 4-input channels (three for the three color channels of the conditioning input color image, and one for the input noisy depth map) and 1-output channel for the output depth map prediction. The input and/or output resolutions of the model could take a variety of values according to an application and/or according to the available training data.

The trained models and iterative diffusion inference process described herein could be used to generate depth and/or optical flow maps from input color images or pair of color images to facilitate a variety of applications, and in a manner that is improved with respect to the amount of training data needed, model size, computational cost to train or the execute for inference, or with respect to other factors. Additionally, the use of the iterative diffusion inference process allows prior information about the depth or optical flow maps to be predicted (e.g., an output from a low-quality or damaged depth sensor, a low-resolution, ambiguous, incomplete, or otherwise low-quality estimate of an optical flow map) to be easily injected into the process, as the ‘initial’ depth or optical flow map presented to the model in the first iteration of the iterative diffusion inference process.

This ability to inject prior depth information allows the methods described herein to produce, in a wholly generative context, images of simulated environments that depict a consistent, wholly model-generated, internal geometry. For example, an initial image of a scene could be generated by a first generative model (e.g., by a text-to-image model). The methods described herein could then be used to generate, for the initial image, an initial depth map for the scene. The initial depth map could then be projected to a point cloud or other durable representation of the geometry of the scene. This geometry could then be rotated and/or translated to determine a second perspective. The point cloud or other representation of the scene's geometry could then be used, with the initial image, to render a second image of the scene from the second perspective. This could include projecting the ‘visible’ aspects of the scene in the initial image onto the rotated and/or translated point cloud, and then generatively (or otherwise) filling in any remaining holes in the projected second image (which would correspond to portions of the scene that were ‘not visible’ in the initial image). The methods described herein could then be applied to the second image to generate a second depth map therefor. The second depth map could then be used to augment the point cloud or other durable representation of the scene's internal geometry, thereby ‘growing’ the scene's geometry in a manner that ‘preserves’ the structure of the geometry that was already ‘seen’ in previous images of the scene.

Another benefit of the iterative diffusion inference process described herein is the ability to run the process multiple times with the same input image(s) to generate respective multiple samples of the underlying depth or optical flow distribution thereof. This can allow the variance or confidence of the output depth or optical flow map to be easily computed, e.g., by performing a pixelwise variance across the set of maps generated for the input image(s). Additionally or alternatively, bimodal (or otherwise multimodal) areas of the distribution can be easily detected by, e.g., detecting regions of bimodality between two (or more) sets of the output depth or flow maps for particular input image(s). Such bimodal regions in a depth map can indicate, e.g., that a mirror, window, or other reflective, transparent, or semi-transparent object is present in the scene and/or that the depiction of the scene is inherently ambiguous with respect to depth, and thus that additional care should be taken in navigating or otherwise interacting with such an bimodal region.

### II. Illustrative Systems

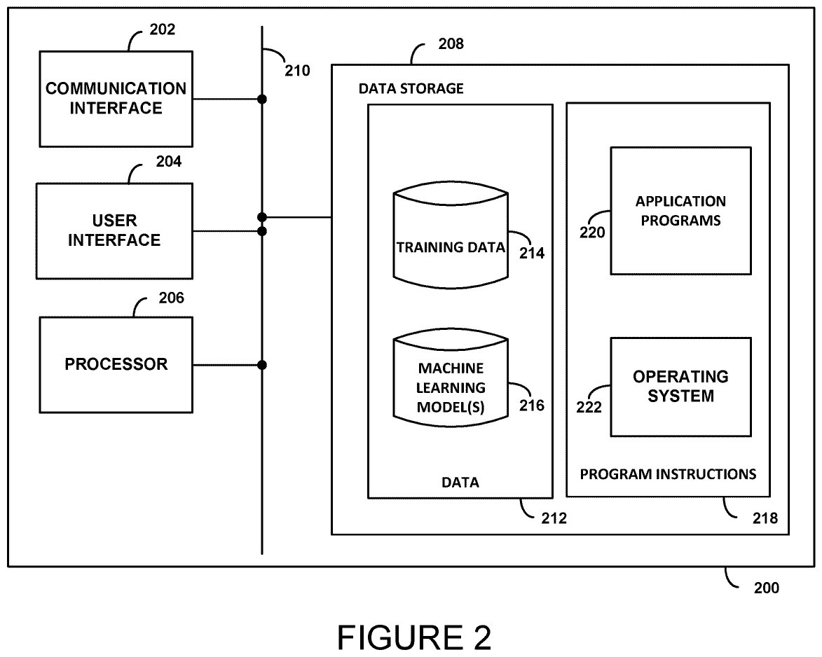

FIG. 2 illustrates an example computing system 200 that may be used to implement the methods described herein. By way of example and without limitation, computing system 200 may be a cellular mobile telephone (e.g., a smartphone), a computer (such as a desktop, notebook, tablet, or handheld computer, a server), elements of a cloud computing system, a robot, a drone, an autonomous vehicle, or some other type of device. It should be understood that computing system 200 may represent a physical computing device such as a server, a particular physical hardware platform on which a machine learning application (training and/or inference) operates in software, or other combinations of hardware and software that are configured to carry out machine learning or other functions as described herein. The computing system 200 could be a central system (e.g., a server, elements of a cloud computing system) that is configured to receive color images or other inputs (e.g., FOV values, incomplete or noisy depth and/or optical flow maps) from a remote system and to responsively transmit, to that remote system, output depth and/or optical flow map(s) generated by applying the image(s) and optional additional inputs to a machine learning model as described herein. Additionally or alternatively, the computing system 200 could be such a remote system, configured to transmit images (and optionally additional inputs) to a central system and receive depth and/or optical flow maps in response, and/or to receive, from the central system, a representation of a model as described herein (e.g., that has been trained by the central system using the methods described herein) and to apply that model locally to an image to generate a depth and/or optical flow map therefrom.

As shown in FIG. 2, computing system 200 may include a communication interface 202, a user interface 204, a processor 206, and data storage 208, all of which may be communicatively linked together by a system bus, network, or other connection mechanism 210.

Communication interface 202 may function to allow computing system 200 to communicate, using analog or digital modulation of electric, magnetic, electromagnetic, optical, or other signals, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port. Communication interface 202 may also take the form of or include a wireless interface, such as a Wifi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 202. Furthermore, communication interface 202 may comprise multiple physical communication interfaces (e.g., a Wifi interface, a BLUETOOTH® interface, and a wide-area wireless interface).

In some embodiments, communication interface 202 may function to allow computing system 200 to communicate with other devices, remote servers, access networks, and/or transport networks.

User interface 204 may function to allow computing system 200 to interact with a user or other entity, for example to receive input from and/or to provide output to the user. Thus, user interface 204 may include input components such as a keypad, keyboard, touch-sensitive or presence-sensitive panel, computer mouse, trackball, joystick, microphone, and so on. User interface 204 may also include one or more output components such as a display screen which, for example, may be combined with a presence-sensitive panel. The display screen may be based on CRT, LCD, and/or LED technologies, or other technologies now known or later developed. User interface 204 may also be configured to generate audible output(s), via a speaker, speaker jack, audio output port, audio output device, earphones, and/or other similar devices.

Processor 206 may comprise one or more general purpose processors—e.g., microprocessors-and/or one or more special purpose processors—e.g., digital signal processors (DSPs), graphics processing units (GPUs), floating point units (FPUs), network processors, tensor processing units (TPUs), or application-specific integrated circuits (ASICs). In some instances, special purpose processors may be capable of image processing, image alignment, merging images, transforming images, executing machine learning models, training machine learning models, among other applications or functions. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or functions disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., functions for executing and/or training a machine learning model) installed on computing system 200. Data 212 may include training data (e.g. individual color images and/or cropped, uncropped, or otherwise modified versions thereof, sets of color images and associated field of view values, depth and/or optical flow maps, etc.) 214 and/or machine learning model(s) 216 that may be determined therefrom or obtained in some other manner.

Application programs 220 may communicate with operating system 222 through one or more application programming interfaces (APIs). These APIs may facilitate, for instance, application programs 220 transmitting or receiving information via communication interface 202, receiving and/or displaying information on user interface 204, and so on.

Application programs 220 may take the form of “apps” that could be downloadable to computing system 200 through one or more online application stores or application markets (via, e.g., the communication interface 202). However, application programs can also be installed on computing system 200 in other ways, such as via a web browser or through a physical interface (e.g., a USB port) of the computing system 200.

### III. Example Machine Learning Models and Training Thereof

A machine learning model as described herein may include, but is not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures. Such a machine learning model can include attention mechanisms (e.g., self-attention matrices or other self-attention features). Such a machine learning model could include a plurality of elements (e.g., attention and/or neural network layers) arranged according to a multi-layer architecture, e.g., a machine learning model as described herein may be configured as a Transformer.

An artificial neural network (ANN) could be configured in a variety of ways. For example, the ANN could include two or more layers, could include units having linear, logarithmic, or otherwise-specified output functions, could include fully or otherwise-connected neurons, could include recurrent and/or feed-forward connections between neurons in different layers, could include filters or other elements to process input information and/or information passing between layers, or could be configured in some other way to facilitate the generation of predicted color palettes based on input images.

An ANN could include one or more filters that could be applied to the input and the outputs of such filters could then be applied to the inputs of one or more neurons of the ANN. For example, such an ANN could be or could include a convolutional neural network (CNN). Convolutional neural networks are a variety of ANNs that are configured to facilitate ANN-based classification or other processing based on images or other large-dimensional inputs whose elements are organized within two or more dimensions. The organization of the ANN along these dimensions may be related to some structure in the input structure (e.g., as relative location within the two-dimensional space of an image can be related to similarity between pixels of the image).

In example embodiments, a CNN includes at least one two-dimensional (or higher-dimensional) filter that is applied to an input; the filtered input is then applied to neurons of the CNN(e.g., of a convolutional layer of the CNN). The convolution of such a filter and an input could represent the color values of a pixel or a group of pixels from the input, in embodiments where the input is an image. A set of neurons of a CNN could receive respective inputs that are determined by applying the same filter to an input. Additionally or alternatively, a set of neurons of a CNN could be associated with respective different filters and could receive respective inputs that are determined by applying the respective filter to the input. Such filters could be trained during training of the CNN or could be pre-specified. For example, such filters could represent wavelet filters, center-surround filters, biologically-inspired filter kernels (e.g., from studies of animal visual processing receptive fields), or some other pre-specified filter patterns.

A CNN or other variety of ANN could include multiple convolutional layers (e.g., corresponding to respective different filters and/or features), pooling layers, rectification layers, fully connected layers, or other types of layers. Convolutional layers of a CNN represent convolution of an input image, or of some other input (e.g., of a filtered, downsampled, or otherwise-processed version of an input image), with a filter. Pooling layers of a CNN apply non-linear downsampling to higher layers of the CNN, e.g., by applying a maximum, average, L2-norm, or other pooling function to a subset of neurons, outputs, or other features of the higher layer(s) of the CNN. Rectification layers of a CNN apply a rectifying nonlinear function (e.g., a non-saturating activation function, a sigmoid function) to outputs of a higher layer. Fully connected layers of a CNN receive inputs from many or all of the neurons in one or more higher layers of the CNN. The outputs of neurons of one or more fully connected layers (e.g., a final layer of an ANN or CNN) could be used to determine information about areas of an input image (e.g., for each of the pixels of an input image) or for the image as a whole.

Neurons in a CNN can be organized according to corresponding dimensions of the input. For example, where the input is an image (a two-dimensional input, or a three-dimensional input where the color channels of the image are arranged along a third dimension), neurons of the CNN(e.g., of an input layer of the CNN, of a pooling layer of the CNN) could correspond to locations in the two-dimensional input image. Connections between neurons and/or filters in different layers of the CNN could be related to such locations. For example, a neuron in a convolutional layer of the CNN could receive an input that is based on a convolution of a filter with a portion of the input image, or with a portion of some other layer of the CNN, that is at a location proximate to the location of the convolutional-layer neuron. In another example, a neuron in a pooling layer of the CNN could receive inputs from neurons, in a layer higher than the pooling layer (e.g., in a convolutional layer, in a higher pooling layer), that have locations that are proximate to the location of the pooling-layer neuron.

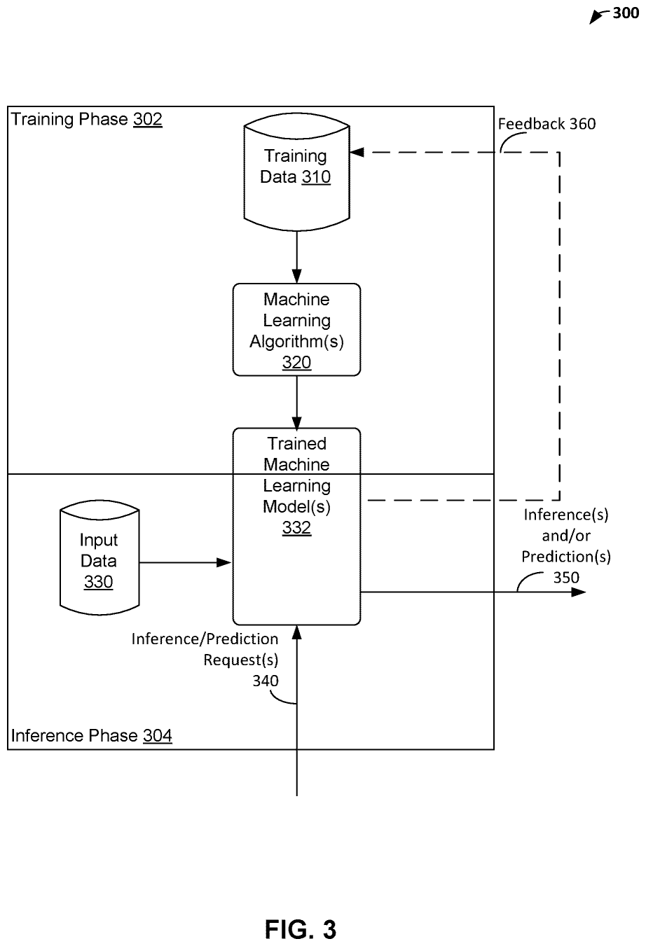

FIG. 3 shows diagram 300 illustrating a training phase 302 and an inference phase 304 of trained machine learning model(s) 332, in accordance with example embodiments. Some machine learning techniques involve training one or more machine learning algorithms, on an input set of training data to recognize patterns in the training data and provide output inferences and/or predictions about (patterns in the) training data. Such output could take the form of filtered or otherwise modified versions of the input, e.g., an input noisy depth or optical flow map could be modified by the machine learning model, conditioned by one or more auxiliary color image inputs thereto, to identify the noise content of the input map, to identify the non-noise content of the input map(i.e., to attempt to predict the ‘true,’ noise-free map), and/or to identify a specified weighted combination of the noise and non-noise contents of the input map. The resulting trained machine learning algorithm can be termed as a trained machine learning model. For example, FIG. 3 shows training phase 302 where one or more machine learning algorithms 320 are being trained on training data 310 to become trained machine learning model 332. Then, during inference phase 304, trained machine learning model 332 can receive input data 330 and one or more inference/prediction requests 340 (perhaps as part of input data 330) and responsively provide as an output one or more inferences and/or predictions 350.

In some examples, such an inference process can include executing the model multiple times. For example, a model could receive as inputs color image(s) and a noisy depth or optical flow image, and output a prediction of the depth or optical flow image and/or the noise content of the input noise or optical flow image based on the image and the noisy depth or optical flow image. Such a model could be used for inference in a generative diffusion context by executing the model a number of times, first with pure noise as the input at the depth or optical flow map input channel(s), and subsequently with the previous depth or optical flow map output corrupted by an amount of additive noise (with the amount of additive noise reducing with each iteration according to a noise schedule). Such a diffusion context also has the benefit of being amenable to improving an initial estimate of the depth map(e.g., a noisy depth or optical flow map, a depth or optical flow map containing holes) by presenting such an initial estimate (corrupted with an amount of additive noise) as the initial input to the depth or optical flow channel(s) of the model for the initial execution of the model.

As such, trained machine learning model(s) 332 can include one or more models of one or more machine learning algorithms 320. Machine learning algorithm(s) 320 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system), a support vector machine, a regression tree, an ensemble of regression trees (also referred to as a regression forest), a decision tree, an ensemble of decision trees (also referred to as a decision forest), or some other machine learning model architecture or combination of architectures, e.g., a Transformer or other multi-layer architecture that is composed of a plurality of sub-models (e.g., ANNs) arranged such that the outputs from many of the sub-models are provided as inputs to other of the sub-models. Machine learning algorithm(s) 320 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results. Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to computing device CD1, where CD1 is intended to execute the trained machine learning model during inference phase 304. Then, during training phase 302, the pre-trained machine learning model can be additionally trained using training data 310, where training data 310 can be derived from kernel and non-kernel data of computing device CD1. This further training of the machine learning algorithm(s) 320 and/or the pre-trained machine learning model using training data 310 of CDI's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to computing device CD1.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350 to kernel components and non-kernel components. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from computing device CD1 executing trained machine learning model(s) 332 and/or input data from one or more computing devices other than CD1.

Input data 330 can include a collection of images provided by one or more sources. The collection of images can include video frames, images resident on computing device CD1, and/or other images. Other types of input data are possible as well.

Inference(s) and/or prediction(s) 350 can include output images, output depth or optical flow maps, numerical values, and/or other output data produced by trained machine learning model(s) 332 operating on input data 330 (and training data 310). In some examples, trained machine learning model(s) 332 can use output inference(s) and/or prediction(s) 350 as input feedback 360. Trained machine learning model(s) 332 can also rely on past inferences as inputs for generating new inferences.

### IV. Example Methods

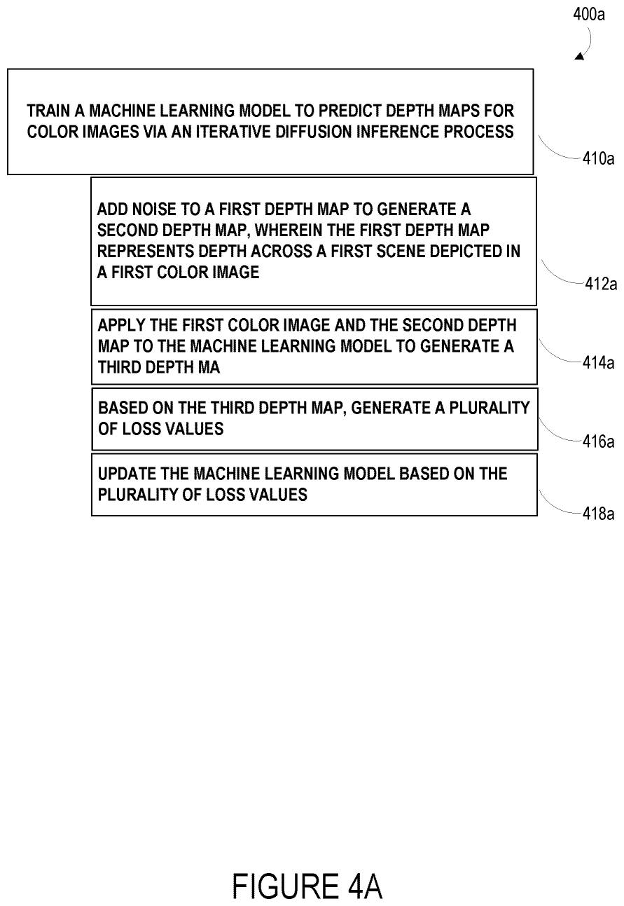

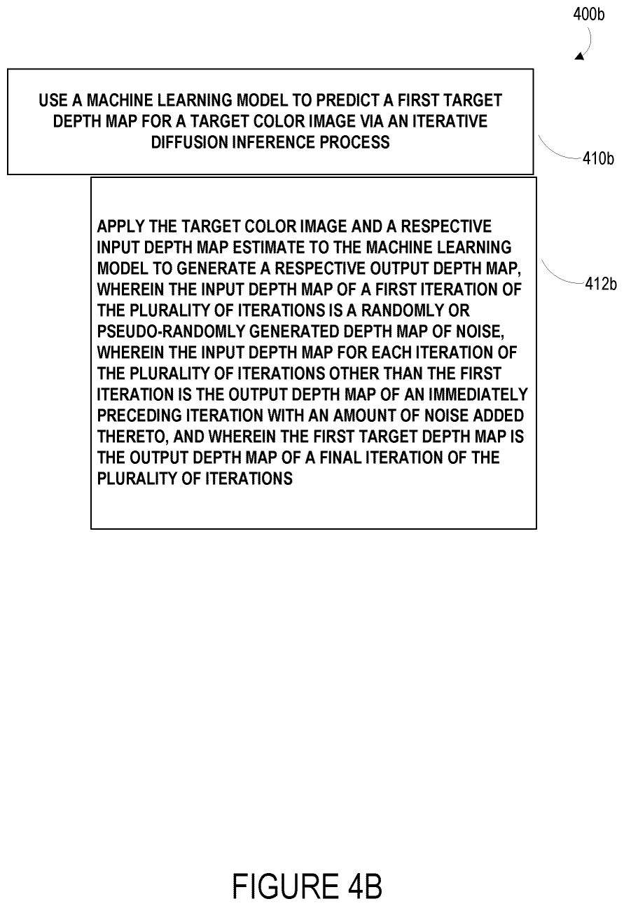

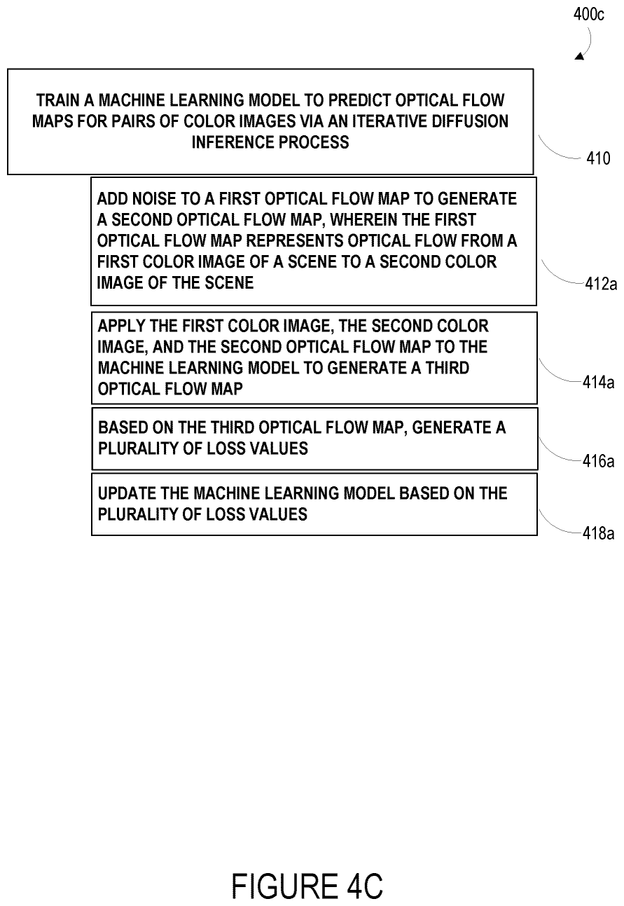

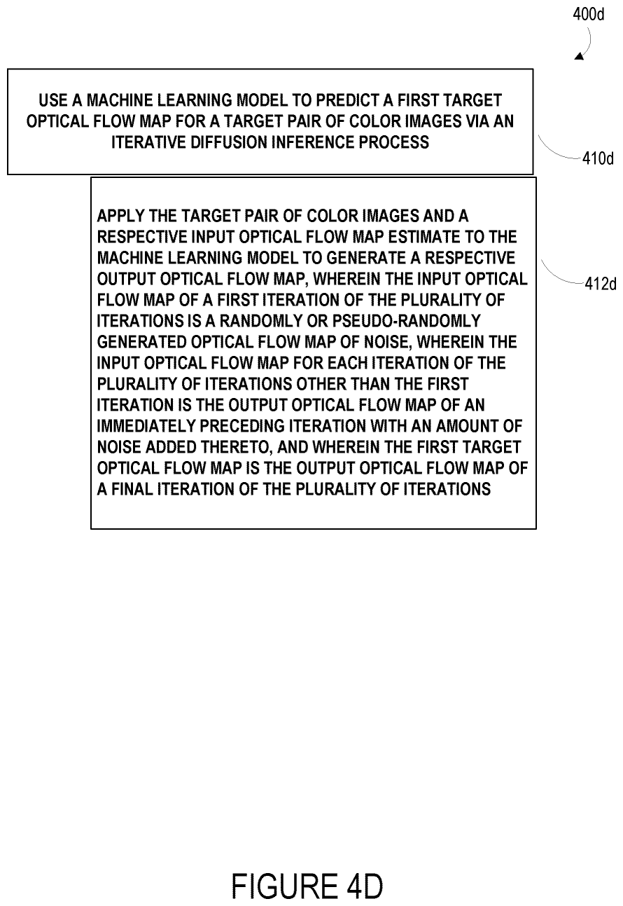

FIG. 4A is a flowchart of an example computer-implemented method 400a. The method 400a includes training a machine learning model to predict depth maps for color images via an iterative diffusion inference process (410a). The training 410a includes adding noise to a first depth map to generate a second depth map, wherein the first depth map represents depth across a first scene depicted in a first color image (412a). The training 410a also includes applying the first color image and the second depth map to the machine learning model to generate a third depth map(414a). The training 410a yet further includes, based on the third depth map, generating a plurality of loss values (416a). The training 410a also includes updating the machine learning model based on the plurality of loss values (428a). The method 400a could include additional or alternative features.

FIG. 4B is a flowchart of an example computer-implemented method 400b. The method 400b includes using a machine learning model to predict a first target depth map for a target color image via an iterative diffusion inference process (410b). The iterative diffusion inference process 410b includes, for a plurality of iterations, applying the target color image and a respective input depth map estimate to the machine learning model to generate a respective output depth map, wherein the input depth map of a first iteration of the plurality of iterations is a randomly or pseudo-randomly generated depth map of noise, wherein the input depth map for each iteration of the plurality of iterations other than the first iteration is the output depth map of an immediately preceding iteration with an amount of noise added thereto, and wherein the first target depth map is the output depth map of a final iteration of the plurality of iterations (412b). The method 400b could include additional or alternative features.

FIG. 4C is a flowchart of an example computer-implemented method 400c. The method 400c includes training a machine learning model to predict optical flow maps for pairs of color images via an iterative diffusion inference process (410c). The training 410c includes adding noise to a first optical flow map to generate a second optical flow map, wherein the first optical flow map represents optical flow from a first color image of a scene to a second color image of the scene (412c). The training 410c also includes applying the first color image, the second color image, and the second optical flow map to the machine learning model to generate a third optical flow map(414c). The training 410c yet further includes, based on the third optical flow map, generating a plurality of loss values (416c). The training 410c also includes updating the machine learning model based on the plurality of loss values (428c). The method 400c could include additional or alternative features.

FIG. 4D is a flowchart of an example computer-implemented method 400d. The method 400d includes using a machine learning model to predict a first target optical flow map for a target pair of color images via an iterative diffusion inference process (410d). The iterative diffusion inference process 410d includes, for a plurality of iterations, applying the target pair of color images and a respective input optical flow map estimate to the machine learning model to generate a respective output optical flow map, wherein the input optical flow map of a first iteration of the plurality of iterations is a randomly or pseudo-randomly generated optical flow map of noise, wherein the input optical flow map for each iteration of the plurality of iterations other than the first iteration is the output optical flow map of an immediately preceding iteration with an amount of noise added thereto, and wherein the first target optical flow map is the output optical flow map of a final iteration of the plurality of iterations (412d). The method 400d could include additional or alternative features.

### V. Experimental Results

The embodiments described herein were implemented in a variety of ways and experimentally assessed, empirically illustrating the benefits of the subject matter of the present disclosure.

### First Experiments

In some experiments, depth map-predicting models (and methods of training thereof) were implemented as the “DepthGen,” model. DepthGen outperformed state of the art (SOTA) baselines on the indoor NYU dataset, and was competitive on the KITTI dataset. Ablation experiments demonstrated that unsupervised pre-training, depth infilling, the L1 loss, and unbiased conditioning all significantly improve performance. As a probabilistic model, DepthGen (and similar models as described herein) provide a variety of benefits. Having the ability to represent multi-modal distributions, these models can resolve depth ambiguities, e.g., due to reflective or transparent surfaces. Such diffusion models can also be easily modified to impute maps based on incomplete initial estimates or other priors, allowing DepthGen (and similar models described herein) to be used to infer missing depth values. This property, along with zero-shot capability the existence of text to image models, to build and experimentally assess a framework for text to 3D scene generation and novel view synthesis.

DepthGen is a diffusion model for monocular depth estimation, and comprises self-supervised pretraining and supervised fine-tuning. Without specialized loss functions or architectures, it achieves SOTA relative error of 0.074 on the NYU benchmark.

To train diffusion models on noisy, incomplete depth data, an L1 loss, depth infilling, and unbiased conditioning can be used to reduce latent distribution shift between training and inference.

DepthGen enables multimodal depth inference and imputation of missing depths e.g., for text-to-3D generation and novel view synthesis.

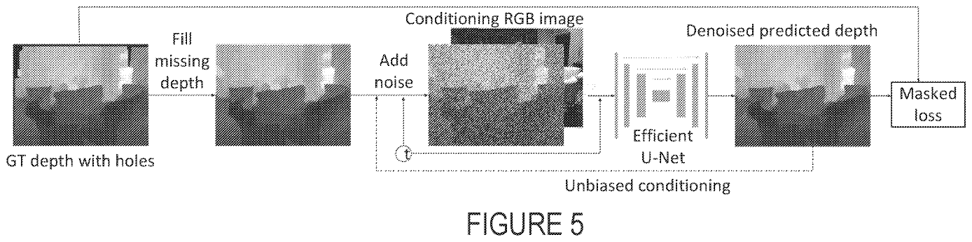

FIG. 5 depicts aspects of a Training Architecture that was experimentally assessed, as described in greater detail below.

Diffusion models are latent-variable generative models trained to transform a sample of a Gaussian (or otherwise-distributed) noise into a sample from data distribution. Training such models includes a forward process that gradually annihilates data by adding noise, as ‘time’ t increases from 0 to 1, and a learned generative process that reverses the forward process, starting from a sample of random noise at t=1 and incrementally adding structure (attenuating noise) as t decreases to 0. A conditional diffusion model conditions the steps of the reverse process; in the case of the depth estimation task experimentally assessed herein, the conditioning signal was an RGB image, x, and the target was a conditional distribution over depth maps, p(y|x).

Central to the model is a denoising network f_{θ} that is trained to take a noisy sample at a timestep t and to predict a less noisy sample therefrom. Using Gaussian noise in the forward process, one can express the training objective over the sequence of transitions (as t slowly decreases) as a sum of non-linear regression losses, i.e.,

$${𝔼}_{( x , y )} {𝔼}_{( t , ϵ} ) {‖ {f}_{θ} ( x , {\underbrace{\sqrt{{γ}_{t}} y + \sqrt{1 - {γ}_{t}} ϵ}}_{{y}_{t}} , t ) - ϵ ‖}_{2}^{2} \qquad ( 1 )$$

where ∈~N(0,I), t~U(0,1), and where yₜ>0 is computed with a pre-determined noise schedule. For inference (e.g., sampling), a random noise sample y₁ is drawn and then f_{θ} is iteratively used to estimate the noise therein, from which one can compute the next latent sample yₛ, for s<t.

DepthGen training included self-supervised pre-training on a generic RGD training dataset, followed by supervised training on an RGB-D training dataset. The pre-trained model was a self-supervised multi-task diffusion model. A Palette model was trained from scratch on four image translation tasks: colorization, inpainting, uncropping, and JPEG artifact removal.

Following this pre-training on the generic RGD training dataset, minor modifications to the architecture were made (including modifications to reduce the dimensionality of the model output channel and the model depth map input channel, from three (for color image pretraining) to one (for depth)). Training then continued on paired RGB and depth data. The training datasets available for depth estimation present substantial challenges for use in such training. The available depth maps are noisy and often contain regions with missing depth values.

The causes for such holes include highly reflective surfaces, light absorbing surfaces, and regions outside the sensor's range of measurement. Holes are largely inconsequential for simple feed-forward nets or regression models, since the training process can be modified to only backpropagate the loss from the subset of pixels with known depth values, ignoring those with missing depth. For diffusion models, on the other hand, such corruption of the training data is more problematic.

Diffusion models perform inference through iterative refinement—in the present case, of a depth map y conditioned on an RGB image x. It starts with a sample of Gaussian noise y₁, and terminates with a sample from the predictive distribution p(y⁰|x). A refinement step from time t to s, with s<t, proceeds by sampling from the parameterized distribution p_{θ}(yₛ|yₜ,x). Simply put, during inference, each step operates on the output from the previous step. In contrast, during training the different steps are somewhat decoupled (see Eqn. 1), where the denoising network operates on a noisy version of the ground truth depth map instead of the output of the previous iteration (reminiscent of teaching forcing in training RNNs). This introduces a distribution shift between training and inference, since the marginal distribution over noisy training depth maps with holes may differ significantly from the distribution of noisy depths at inference time, which should ideally (since the model does not learn the distribution of holes in the loss) be a noisy version of the true, complete depth maps (from a perfect, noiseless sensor for instance). This has a significant negative impact 156 on model performance. This problem is further exacerbated by the presence structured or heavy-tailed noise in training depth maps.

These issues were effectively mitigated by the following modifications during training:

Depth interpolation. To reduce distribution shift between training and inference, missing depth values were imputed in the training dataset. Several ways to accomplish this were evaluated, including various interpolation schemes, and include the use of DepthGen (trained with nearest neighbor interpolation infilling) to infill missing depth. Empirically, it was found that two straightforward steps performed approximately as well as more sophisticated approaches. In particular, the results herein show that nearest neighbor interpolation was sufficient to impute missing depths for indoor training data. For outdoor training data, nearest neighbor interpolation was also used except for sky regions, as they were often large and were much further from the camera than adjacent objects in the image. Instead, a sky segmenter model was used to identify ‘sky’ portions of the training images, and based on that output all sky pixels were set to be the maximum modeled depth (here, 80 m). Despite the imputation of missing depths, the training loss was only computed at pixels with known (vs infilled) depth.

Algorithm 1 Train step w/infilling and unbiased cond.

```
Input: rgb image x, depth map y
t ← U(0, 1)
ϵ ← N(0, 1)
valid_mask = y > 0
y = fill_holes(y)
yₜ = Vγₜ * y + V1 − γₜ * ϵ
if unbiased_cond then
  ϵ_{pred} = stop_grad(f_{θ}(x, yₜ, t))
  y_{pred} = (yₜ − V1 - γₜ * ϵ_{pred})/Vγₜ
  yₜ = Vγₜ * y_{pred} + V1 − γₜ * ϵ
  ϵ = (yₜ − Vγₜ * y)/V1 − γₜ
end if
ϵ_{pred} = f_{θ}(x, yₜ, t)
loss = reduce_mean(|ϵ − ϵ_{pred}|[valid_mask])
```

Unbiased yₜ conditioning. Another approach to reducing the bias in the latent marginal distribution of yₜ between training and inference was to construct yₜ using the model's output instead of the ground truth depth. This was done by modifying the training procedure (Algorithm 1) to run one forward pass of the model and then to build yₜ by adding noise to the model's output rather than the original training depth map used to generate that first model output. Gradients were not propagated for this forward pass. This slowed training by about 15% on a TPU v4. This modified training method may be referred to as unbiased yₜconditioning.

This unbiased conditioning was performed during fine-tuning only, not during supervised depth pre-training. This was because, early in training, the depth predictions are more likely to be more inaccurate. Thus, the latent marginals over the noisy training depth maps would be much closer to the desired true marginals than those produced by adding noise to the model's outputs. Thus, performing unbiased conditioning early in supervised pre-training is not recommended. A curriculum could also be used to gradually introduce unbiased conditioning in the later stages of supervised pre-training. This would also introduce additional hyper-parameters, and so was note experimentally investigated here.

Loss. While the L2 loss in Eqn. 1 is appropriate for noise-free training data with additive Gaussian noise, good performance has been reported with an L1 loss during training for image to image translation models. Given the possibility of substantial noise in depth data, especially for large depths and near holes, the robustness afforded by the L1 loss is also useful in training the RGB-to-depth diffusion models (or RGB-to-optical flow diffusion models) described herein.

For unsupervised pre-training, the ImageNet-1K and Places365 datasets were used and training performed on the self-supervised tasks of colorization, inpainting, uncropping, and JPEG decompression,

Indoor model: For supervised image-to-depth pre-training of the indoor model the following two datasets (with dataset mixing at the batch level) were used:

ScanNet is a dataset of 2.5M images captured using a Kinect v1-like sensor. It provides depth maps at 640×480 and RGB images at 1296×968.

SceneNet RGB-D is a synthetic dataset of 5M images generated by rendering ShapeNet objects in scenes from SceneNet at a resolution of 320×240.

For indoor fine-tuning and evaluation the NYU depth v2 Dataset was used, a commonly used dataset for evaluating indoor depth prediction models. It provides aligned image and depth maps at 640×480 resolution. The official split, consisting of 50 k images for training and 654 images for evaluation, was used herein. The predicted depth maps from DepthNet were resized to the full resolution using bilinear up-sampling before evaluation. Evaluation was performed on a cropped region.

Outdoor model: For outdoor model training the Waymo Open Dataset was used, a large-scale driving dataset consisting of about 200 k frames. Each frame provides RGB images from 5 cameras and LiDAR maps. The RGB images from the FRONT, FRONT LEFT, and FRONT RIGHT cameras and depth maps from the TOP LiDAR were used to build about 600 k aligned RGB depth maps.

For subsequent fine-tuning and evaluation, KITTI was used, an outdoor driving dataset that provides RGB images and LiDAR scans at resolutions close to 1226×370. A training/test split of 26k training images and 652 test images was used. The predicted depth from DepthGen was up-sampled to the full resolution using bilinear interpolation before evaluation. Evaluation was performed on a cropped region.

Data Augmentation and Preprocessing. Random horizontal flip data augmentation was used for supervised depth training. Where needed, images and depth maps were resized using bilinear interpolation to the model's resolution for training. Diffusion models expect inputs and generate outputs in the range [−1,1]. For the indoor model a max depth of 10 meters was applied, and for the outdoor model the depth maps were normalized to the range with a maximum depth of 80 meters.

TABLE 1
Comparison of performances on the NYU-Depth-v2 dataset.

| Method | Architecture | &delta₁ ↑ | δ₂ ↑ | δ₃ ↑ | REL↓ | RMS↓ | log₁₀↓ |
|---|---|---|---|---|---|---|---|
| DORN [1] | ResNet-101^{†} | 0.828 | 0.965 | 0.992 | 0.115 | 0.509 | 0.051 |
| VNL [2] | ResNeXt-101^{†} | 0.875 | 0.976 | 0.994 | 0.108 | 0.416 | 0.048 |
| BTS [3] | DenseNet-161^{†} | 0.885 | 0.978 | 0.994 | 0.110 | 0.392 | 0.047 |
| DAV [4] | DRN-D-22^{†} | 0.882 | 0.980 | 0.996 | 0.108 | 0.412 | — |
| Trans Depth [5] | Res-50 + ViT-B^{†} | 0.900 | 0.983 | 0.996 | 0.106 | 0.365 | 0.043 |
| DPT [6] | Res-50 + ViT-B^{†‡} | 0.904 | 0.988 | 0.998 | 0.110 | 0.357 | 0.045 |
| AdaBins [7] | E-B5 + Mini-ViT^{†} | 0.903 | 0.984 | 0.997 | 0.103 | 0.364 | 0.044 |
| BinsFormer [8] | Swin-Large^{†} | 0.925 | 0.989 | 0.997 | 0.094 | 0.330 | 0.040 |
| PixelFormer [9] | Swin-Large^{†} | 0.929 | 0.991 | 0.998 | 0.090 | 0.322 | 0.039 |
| MIM [10] | SwinV2-L^{T} | 0.949 | 0.994 | 0.999 | 0.083 | 0.287 | 0.035 |
| AiT-P [11]⁺ | SwinV2-L^{T} | 0.953 | 0.993 | 0.999 | 0.076 | 0.279 | 0.033 |
| DepthGen (ours) | | | | | | | |
| samples = 1 | Efficient U-Net^{T‡} | 0.944 | 0.986 | 0.995 | 0.075 | 0.324 | 0.032 |
| samples = 2 | Efficient U-Net^{T‡} | 0.944 | 0.987 | 0.996 | 0.074 | 0.319 | 0.032 |
| samples = 4 | Efficient U-Net^{T‡} | 0.946 | 0.987 | 0.996 | 0.074 | 0.315 | 0.032 |
| samples = 8 | Efficient U-Net^{T‡} | 0.946 | 0.987 | 0.996 | 0.074 | 0.314 | 0.032 |

^{T}indicates methods that use unsupervised pretraining,
^{†}indicates supervised pretraining and
^{‡}indicates methods with supervised depth pretraining on auxiliary data.
Best/second best/third best results are bolded/underlined/italicized respectively.
↓denotes lower is better and
↑ denotes higher is better.

The predominant architecture for diffusion models is the U-Net developed for the DDPM model, and later improved in several respects. For DepthGen, the Efficient U-Net architecture, which was developed for Imagen, was used. The Efficient U-Net architecture is more efficient that the UNets used in prior work, because it has fewer self-attention layers, fewer parameters and less computation at higher resolutions, along with other adjustments that make it well suited to training medium resolution diffusion models.

Several minor changes were made to this architecture to adapt it for image-to-depth models. The text cross-attention layers were dropped, but the self-attention layer was retained. Efficient U-Net has six input and three output channels, since the target is a RGB image (input consists of a 3-channel source RGB image and a 3-channel noisy target image concatenated along the channel dimension). For depth models, since the output is a scalar output image, the architecture was modified to have four input channels and one output channel. To accomplish this modification, the input and output convolutional kernels were re-initialized before the supervised depth pretraining stage.

Resolution. The re-trained Palette model was trained for images at a resolution of 256×256. For training depth models, resolutions that were close to this were chosen while preserving the aspect ratios of the original depth training datasets. The indoor model was trained at 320×240. For Waymo 384×256 was used and for KITTI 416×128 was used. The model did not contain learned positional embeddings so it was easily pretrained and finetuned at different resolutions.

The self-supervised model was trained for 2.8M steps with an L₂loss and a mini-batch size of 512. Other hyperparameters were similar to those in the original Palette publication. The depth models were trained with L₁ loss. A constant learning rate of 1e-4 was used during supervised depth pretraining, switching to a slightly lower learning rate of 3e-5 during finetuning, which was experimentally observed to achieve slightly better results. Learning rate warmup over 10 k steps was used for all models. All depth models were trained with a smaller mini-batch size of 64. The indoor depth model was trained on a mix of ScanNet and SceneNet RGBD for 2M steps and then fine-tuned on NYU for 50 k steps. The outdoor depth model was trained on Waymo for 0.9M steps and fine-tuned on KITTI for 50 k steps. Other details, like the optimizer and the use of EMA were similar to those outlined in Saharia et al., 2022.

The DDPM sampler was used with 128 denoising steps. Increasing the number of denoising steps further did not greatly improve performance.

For both the NYU depth v2 and KITTI datasets the absolute relative error (REL), root mean squared error (RMS), and accuracy metrics (δᵢ<1.251 for i ∈1,2,3) are reported. For NYU absolute error of log depths (log ₁₀) is also reported. For KITTI the squared relative error (Sq-rel) and root mean squared error of log depths (RMS log) are also reported.

Table 1 shows the results on NYU depth v2. A state-of-the-art absolute relative error of 0.074 was achieved. Table 2 shows results on KITTI, where the embodiments described herein performed competitively with prior work. Results with averaging depth maps from one or more samples are reported. Note that most prior work reports average over two samples obtained by left-right reflection of the input image.

TABLE 2
Comparison of performances on the KITTI dataset.

| Method | Backbone | δ₁↑ | δ₂↑ | δ₃↑ | REL ↓ | Sq-rel ↓ | RMS ↓ | RMS log ↓ |
|---|---|---|---|---|---|---|---|---|
| Godard et al. [11] | ResNet-50 | 0.861 | 0.949 | 0.976 | 0.114 | 0.898 | 4.935 | 0.206 |
| Johnston et al. [12] | ResNet-101^{†} | 0.889 | 0.962 | 0.982 | 0.106 | 0.861 | 4.699 | 0.185 |
| Gan et al. [13] | ResNet-101 | 0.890 | 0.964 | 0.985 | 0.098 | 0.666 | 3.933 | 0.173 |
| DORN [1] | ResNet-101^{†} | 0.932 | 0.984 | 0.994 | 0.072 | 0.307 | 2.727 | 0.120 |
| VNL [2] | ResNext-101^{†} | 0.938 | 0.990 | 0.998 | 0.072 | — | 3.258 | 0.117 |
| PGA-Net [14] | ResNet-50^{†} | 0.952 | 0.992 | 0.998 | 0.063 | 0.267 | 2.634 | 0.101 |
| BTS [3] | DeaseNet-161^{†} | 0.956 | 0.993 | 0.998 | 0.059 | 0.245 | 2.756 | 0.096 |
| TransDepth [5] | ResNet-50 + ViT-B^{†} | 0.956 | 0.994 | 0.999 | 0.064 | 0.252 | 2.755 | 0.098 |
| DPT [6] | ResNet-50 + ViT-B^{†‡} | 0.959 | 0.995 | 0.999 | 0.062 | — | 2.573 | 0.092 |
| AdaBins [7] | E-B5 + mini-ViT^{†} | 0.964 | 0.995 | 0.999 | 0.058 | 0.190 | 2.360 | 0.088 |
| BinsFormer [8] | Swin-Large^{†} | 0.974 | 0.997 | 0.999 | 0.052 | 0.151 | 2.098 | 0.079 |
| PixelFormer [9] | Swin-Large^{†} | 0.976 | 0.997 | 0.999 | 0.051 | 0.149 | 2.081 | 0.077 |
| MIM [10] | SwinV2-L^{T} | 0.977 | 0.998 | 1.000 | 0.050 | 0.139 | 1.966 | 0.075 |
| DepthGen (ours) | | | | | | | | |
| samples = 1 | Efficient U-Net^{T‡} | 0.951 | 0.991 | 0.997 | 0.064 | 0.389 | 3.104 | 0.103 |
| samples = 2 | Efficient U-Net^{T‡} | 0.951 | 0.991 | 0.998 | 0.064 | 0.378 | 3.07 | 0.102 |
| samples = 4 | Efficient U-Net^{T‡} | 0.951 | 0.991 | 0.998 | 0.064 | 0.373 | 3.052 | 0.102 |
| samples = 8 | Efficient U-Net^{T‡} | 0.953 | 0.991 | 0.998 | 0.064 | 0.356 | 2.985 | 0.100 |

^{T}indicates methods that use unsupervised pretraining,
^{†}indicates supervised pretraining, and
^{‡}indicates methods with supervised depth pretraining on auxiliary data.
Best/second best/third best results are bolded/underlined/italicized respectively.
↓ denotes lower is better and
↑denotes higher is better.
E-B5: EfficientNet-B5.

TABLE 3
Ablations for pre-training (before fine-tuning),
showing absolute relative error with a
single sample for NYU and KITTI.

| | NYU ↓ | KITTI ↓ |
|---|---|---|
| Training from scratch | 0.155 | 0.103 |
| Self-supervised pre-training only | 0.116 | 0.086 |
| Supervised pre-training only | 0.081 | 0.075 |
| Self-supervised & supervised pre-train | 0.075 | 0.064 |

TABLE 4
Ablations for handling incomplete depth
showing absolute relative error with a
single sample for NYU and KITTI.

| | NYU ↓ | KITTI ↓ |
|---|---|---|
| Baseline | 0.079 | 0.115 |
| Unbiased conditioning only | 0.076 | 0.075 |
| Infilling only | 0.077 | 0.066 |
| Unbiased conditioning and infilling | 0.075 | 0.064 |

Ablation experiments show that both pre-training and accounting for missing depth were contributors to model performance. Table 3 shows that both self-supervised pre-training and supervised depth pretraining are important, with supervised depth training having a larger impact. Table 4 shows that depth infilling was very important for the outdoor KITTI dataset. It had less impact on NYU, which may be related to KITTI having sparser depth maps. In the absence of filled depth maps, unbiased conditioning significantly improved results, especially on KITTI. Even with depth infilling, unbiased conditioning consistently improved performance for both indoor and outdoor datasets. Additionally, the choice of loss function is evaluated in Table 5. The L₁ loss yielded better performance than L₂, likely because L₁ is more robust to noise at larger depths.

TABLE 5
Ablation for L₁ vs L₂ loss showing
absolute relative error with a
single sample on NYU and KITTI

| | NYU ↓ | KITTI ↓ |
|---|---|---|
| L₂ | 0.085 | 0.071 |
| L₁ | 0.075 | 0.064 |

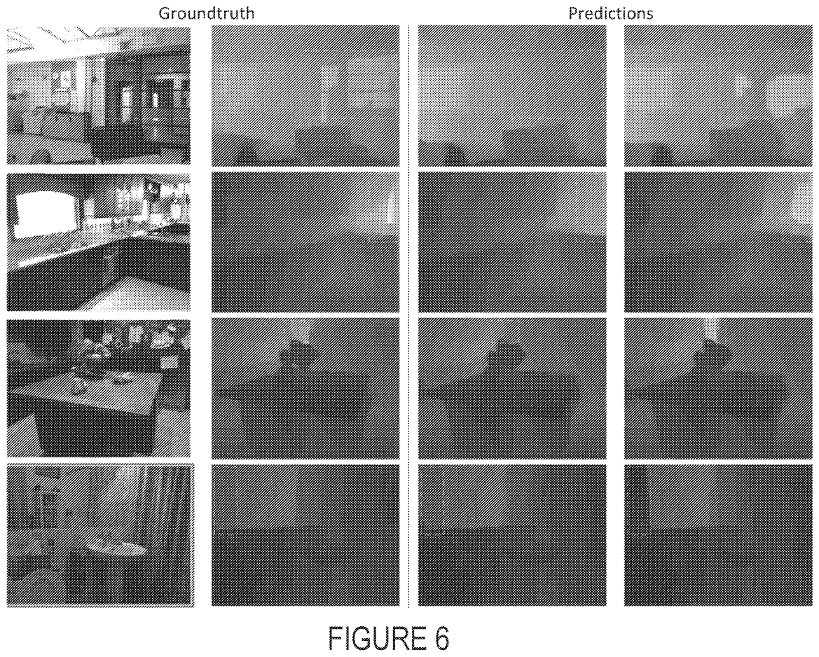

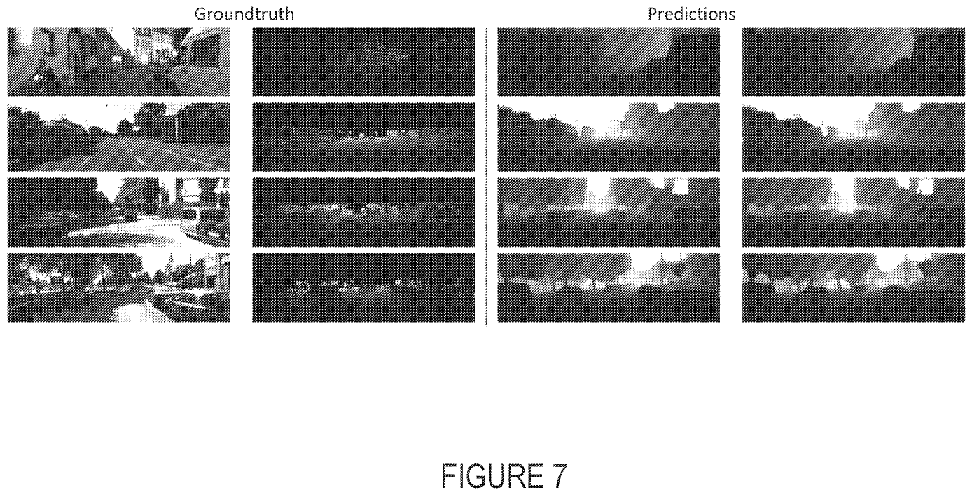

One strength of diffusion models, like those described herein, is their ability to capture complex multimodal distributions. This can be effective in representing depth uncertainty, especially where there may exist natural depth ambiguities, e.g., in cases of transparency when looking through a window. FIGS. 6 and 7 present multiple samples on the NYU and KITTI datasets which show that the model captured multimodality in sensor data and provides plausible samples in case of ambiguities.

FIG. 6: Examples of multimodal predictions on the NYU Depth V2 val dataset. Rows 1-2 contain glass doors/windows where the model learned to predict the depth for either the glass surface or the surface behind it. Row 3 has a dark area next to the refrigerator for which the depth is unclear from RGB alone. In row 4 the model hallucinates the reflected door as a bath cabinet, which seems plausible from the RGB image

FIG. 7: Multimodal depth predictions on the KITTI val dataset.

One advantage of diffusion models is the ease with which one can zero-shot impute one part of an image (or depth map) conditioned on the rest of the image (or depth map).

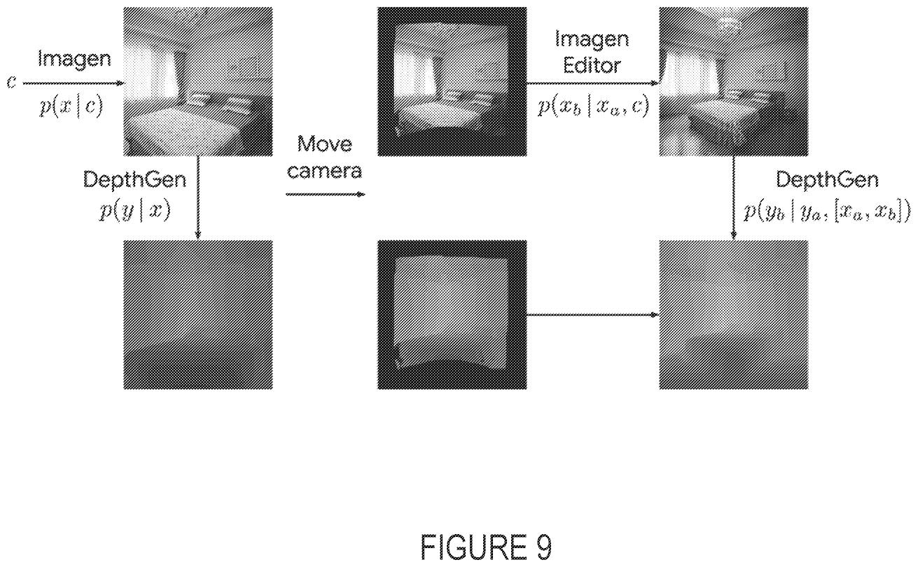

Here, this property was leveraged to build a limited but effective text-to-3D scene generation pipeline. As depicted in FIG. 9, the Imagen text-to-image model was used to generate an image, given text c, to which DepthGen was applied (zero-shot) to sample a corresponding depth map. The “camera” was then “moved” and the RGBD point cloud rendered from the new camera pose. Of course this only provides RGB and depth values at a subset of pixels in the new frame since the fields of view are different. The missing pixels were inferred using diffusion models (i.e., the Imagen Editor for the RGB and DepthGen for depth).

Let xₐ and yₐ be the RGB and depth values at pixel locations rendered from the new camera pose respectively, and let x_{b} and y_{b} correspond to lines of sight not visible in the original frame. The missing RGB values were inferred first, i.e., p(x_{b}|xₐ, c), using the uncropping/inpainting capability of the Imagen Editor. DepthGen was then used to impute the missing depth values, i.e., sampling from p(y_{b}|yₐ, [xₐ, x_{b}]).

The replacement method was used to sample the unknown depths y_{b} conditioned on existing depths yₐ and the image x=[xₐ, x_{b}].

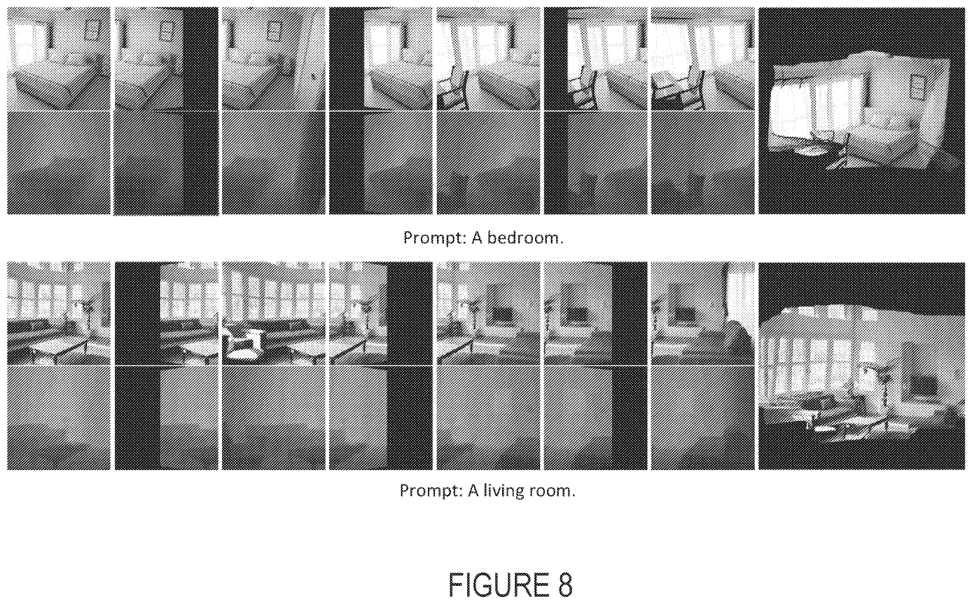

FIG. 8: Text to 3D samples. Given a text prompt, an image was first generated using Imagen (first row of first column), after which depth was estimated (second row of first column). Subsequently the “camera” was “moved” to reveal new parts of the scene, which were then infilled using an image completion model and DepthGen (which conditions on both the incomplete depth map and the filled image). At each step, newly generated RGBD points were added to a global point cloud which is visualized in the rightmost column.

FIG. 9: Pipeline for iteratively generating a 3D scene conditioned on text c=A bedroom.

### Second Experiments

The training of useful diffusion models for monocular depth and optical flow inference can be limited by the amount and quality of available training data for those tasks. Given the limited availability of labelled training data, a training pipeline as described herein was implemented and experimentally assessed. This training pipeline included multi-task self-supervised pre-training followed by supervised pre-training using a combination of real and synthetic data. Multi-task self-supervised pre-training leverages the strong performance of diffusion models on tasks like colorization and inpainting. Experimental results provided herein show that supervised (pre-) training with a combination of real and large-scale synthetic data improves performance significantly.

Additionally, many existing real datasets for depth and optical flow have noisy and incomplete ground truth annotations. This presents a challenge for conventional training frameworks and iterative sampling in diffusion models, leading to distribution shifts between training and inference. To mitigate these issues, the present disclosure provides a number of improvements, includes the use of an L₁ loss for robustness, infilling missing depth values during training, and step-unrolled denoising diffusion. These aspects of the embodiments described herein were shown, through ablation experiments, to be important for both depth and flow estimation.

The present disclosure provides, among other things:

A formulation of optical flow and monocular depth estimation as image to image translation with generative diffusion models, without specialized loss functions and model architectures.

A number of solutions to several important issues with respect to the training data used to train such models. For both tasks, to mitigate distribution shift between training and inference with noisy, incomplete data, we infilling, step-unrolling, and an L₁ loss during training can be used to provide improved results. For flow, to improve generalization, a new dataset mixture for pre-training is disclosed herein, yielding a RAFT baseline that outperforms all published methods in zero-shot performance on the Sintel and KITTI training benchmarks.

The diffusion models described herein are competitive with or surpass SOTA for both tasks. For monocular depth estimation a SOTA relative error of 0.074 was obtained on the NYU dataset, and competitive performance was obtained on KITTI. For flow, diffusion surpassed the stronger RAFT baseline by a large margin in pre-training and the fine-tuned model achieved an Fl-all outlier rate of 3.26% on the public KITTI test benchmark, ~25% lower than the best published method.

The diffusion model described herein is also shown to capture flow and depth uncertainty, and the iterative denoising process enables zero-shot, coarse-to-fine refinement, and imputation.

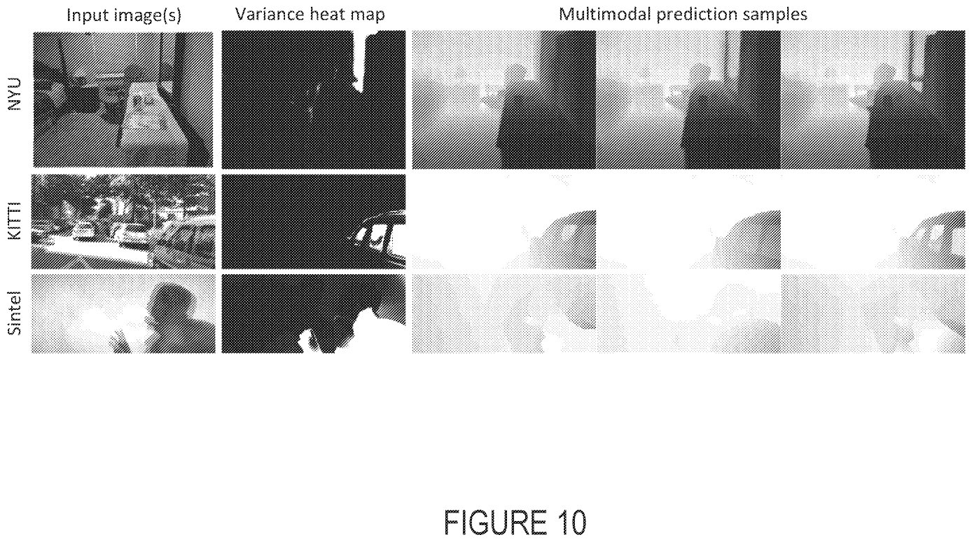

FIG. 10: Examples of multi-modal prediction on depth (NYU) and optical flow (Sintel and KITTI). Each row shows an input image (or overlaid two images for optical flow), a variance heat map from 8 samples, and 3 individual samples. The model provided herein captured multi-modal samples on uncertain/ambiguous cases, such as reflective (e.g. mirror on NYU), transparent (e.g. vehicle window on KITTI), and translucent (e.g. fog on Sintel) regions. High variance also exists near object boundaries due to inaccurate estimates, which are often challenging cases for optical flow, and also partially originate from noisy ground truth measurements for depth.

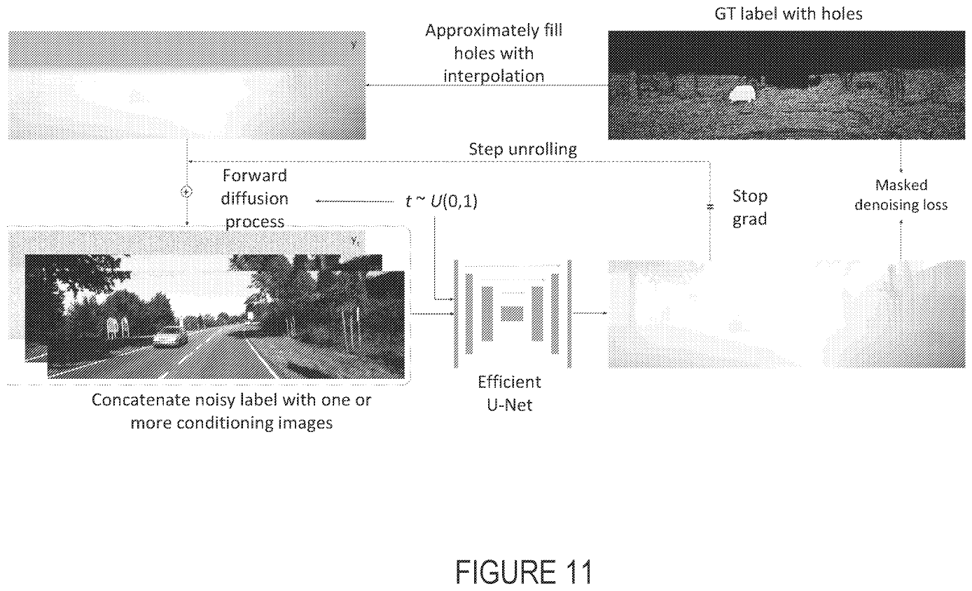

FIG. 11: Training architecture. Given ground truth flow/depth, missing values were first infilled using interpolation. Then, noise was added to the label map and used to train a neural network to model the conditional distribution of the noise given the RGB image(s), noisy label, and time stamp. One can optionally unroll the denoising step(s) during training (with stop gradient) to bridge the distribution gap between training and inference for yₜ.

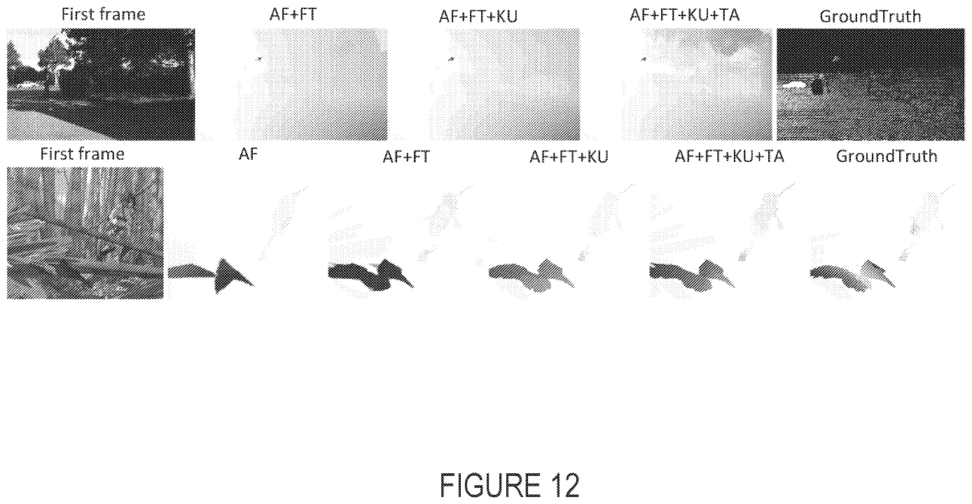

FIG. 12: Effects of adding synthetic datasets in pretraining. Diffusion models trained only with AutoFlow (AF) tend to provide very coarse flow estimates and can hallucinate shapes. The addition of FlyingThings (FT), Kubric (KU), and TartanAir (TA) removed the AF-induced bias toward polgonal-shaped regions, and significantly improved flow quality on fine detail, e.g. trees, thin structures, and motion boundaries.

In contrast to the conventional monocular depth and optical flow methods, which rely on extensive usage of specialized domain knowledge on their architecture designs, the embodiments described herein include simple, generic architectures and loss functions. The inductive bias of state-of-the-art architectures and losses is replaced, in the present embodiments, with a powerful generative model along with a combination of self-supervised pre-training and supervised training on both real and synthetic data.

The denoising diffusion model (FIG. 11) takes a noisy version of the target map(a depth or optical flow map) as input, along with the conditioning signal (one RGB image for depth and two RGB images for flow). The denoiser provides a noise-free estimate of the target map(which may be provided as an estimate of the noise in the input, an estimate of the signal in the input, an estimate of a specified weighted combination of the noise and signal in the input, or some other representation of the target map, depending on the specific loss parameterization used). The training loss penalizes residual error in the denoised map, which is distinct from typical image reconstruction losses used in optical flow estimation.

Because training data with annotated ground truth is limited for many dense vision tasks, the experiments and embodiments described herein make extensive use of synthetic data. AutoFlow has recently emerged as a powerful synthetic dataset for training flow models. However, training on AutoFlow alone was insufficient, as the diffusion model appeared to devote a significant fraction of its representational capacity to represent the shapes of AutoFlow regions, rather than solving for correspondence directly. As a result, models trained on AutoFlow alone exhibited a strong bias to generate flow fields with polygonal shaped regions, much like those present in the AutoFlow dataset, often ignoring the shapes of boundaries in the two-frame RGB inputs (e.g., see FIG. 12).

To mitigate bias induced by AutoFlow in training, three additional synthetic datasets were used during training, namely, FlyingThings3D, Kubric, and TartanAir. Starting from a model pre-trained on AutoFlow for compute efficiency, a greedy mixing strategy was then used where the relative ratio of the previous mixture was fixed and the proportion of the newly added dataset was tuned. Zero-shot testing of the model on Sintel and KITTI (see Table 6 and FIG. 12) showed substantial performance gains with each additional synthetic dataset.

Pre-training was also important for depth estimation (see Table 12). Separate indoor and outdoor models were trained. For the indoor model a mix of ScanNet and SceneNet RGB-D was used for pre-training. The outdoor model was pre-trained on the Waymo Open Dataset.

Algorithm 1 Denoising diffusion train step with infilling and step unrolling

| | |
|---|---|
| 1: | x ← conditioning images, y ← flow or depth map, mask ← binary mask of known values |
| 2: | t ~ U(0, 1), ϵ ~ N(0, 1) |
| 3: | y = fill_holes_with_interpolation(y) |
| 4: | yₜ = Vγₜ * y + V1 − γₜ * ϵ |
| 5: | if unroll_step then |
| 6: | ϵ_{pred} = stop_gradient(f_{θ}(x, yₜ, t)) |
| 7: | y_{pred} = (yₜ − V1 − γₜ * ϵ_{pred})/Vγₜ |
| 8: | yₜ = Vγₜ * y_{pred} + V1 − γₜ * ϵ |
| 9: | ϵ = (yₜ − Vγₜ * y)/V1 − γₜ |
| 10: | end if |
| 11: | ϵ_{pred} = f_{θ}(x, yₜ, t) |
| 12: | loss = reduce_mean(\|ϵ − ϵ_{pred}\|[mask]) |

Ground truth annotations for real-world depth or flow data are often sparse and noisy, due to, e.g., highly reflective surfaces, light absorbing surfaces, dynamic objects, etc. While regression-based methods can simply compute the loss on pixels with valid ground truth, corruption of the training data is more challenging for diffusion models. Diffusion models perform inference through iterative refinement of the target map y conditioned on RGB image data x. It starts with a sample of Gaussian (or otherwise-distributed) noise y₁, and terminates with a sample from the predictive distribution p(y₀|x). A refinement step from time t to s, with s<t, proceeds by sampling from the parameterized distribution po (yₛ[yₜ,x); each step operates on the output from the previous step. During training, however, the denoising steps are decoupled (see Eqn. 1), where the denoising network operates on a noisy version of the ground truth depth map instead of the output of the previous iteration (reminiscent of teaching forcing in RNN training). Thus there is a distribution shift between marginals over the noisy target maps during training and inference, because the ground truth maps have missing annotations and heavy-tailed sensor noise while the noisy maps obtained from the previous time step at inference time should not. This distribution shift can have a negative impact on model performance. Nevertheless, with the following modifications during training these problems are able to be mitigated effectively.

Infilling. One way to reduce the distribution shift is to impute the missing ground truth. Several ways were evaluated, including simple interpolation schemes and inference using the model (trained with nearest neighbor interpolation). Nearest neighbor interpolation was sufficient to impute missing values in the ground truth maps in the depth and flow field training data.

Despite the imputation of missing ground truth depth and flow values, the training loss was only computed and backpropagated from pixels with known (not infilled) ground truth depth. This is referred to as the masked denoising loss (see FIG. 11).

Step-unrolled denoising diffusion training. A second way to mitigate distribution shift in the yₜ marginals in training and inference is to construct yₜ from model outputs rather than ground truth maps. One can do this by slightly modifying the training procedure (see Algorithm 1) to run one forward pass of the model and build yₜ by adding noise to the model's output rather than the training map. Gradients were not propagated for this forward pass. This process, which may be called step-unrolled denoising diffusion, slows training only marginally (~15% on a TPU v4).

Step-unrolled denoising diffusion was only performed during model fine-tuning. Early in training the denoising predictions are inaccurate, so the latent marginals over the noisy target maps will be closer to the desired true marginals than those produced by adding noise to denoiser network outputs.

L₁ denoiser loss. While the L₂ loss in Eqn. 1 is ideal for Gaussian noise and noise-free ground truth maps, in practice, real ground truth depth and flow fields are noisy and heavy tailed; e.g., for distant objects, near object boundaries, and near pixels with missing annotations. The robustness afforded by the L₁ loss may therefore be useful in training the neural denoising network.

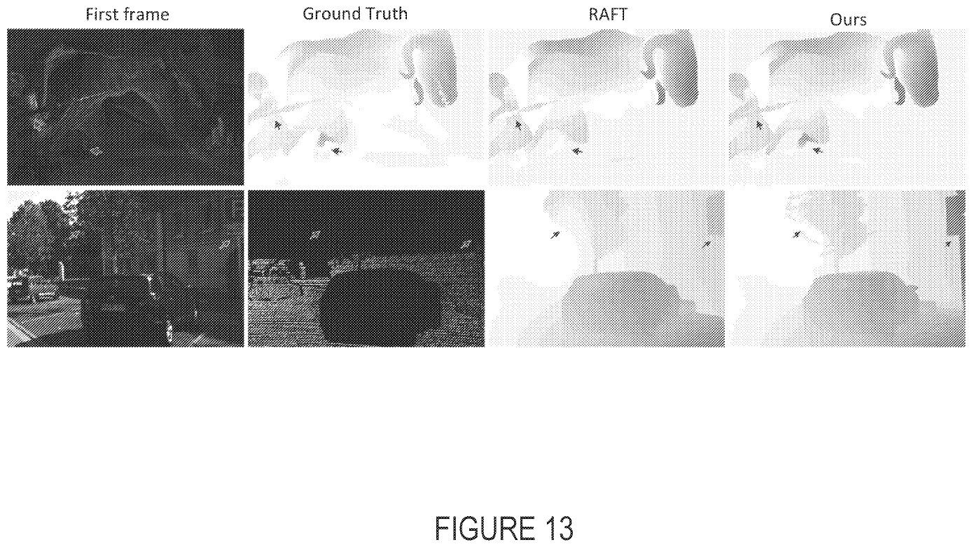

FIG. 13: Visual results comparing RAFT with the method described herein after pretraining. Note that Ours does much better on fine details and ambiguous regions

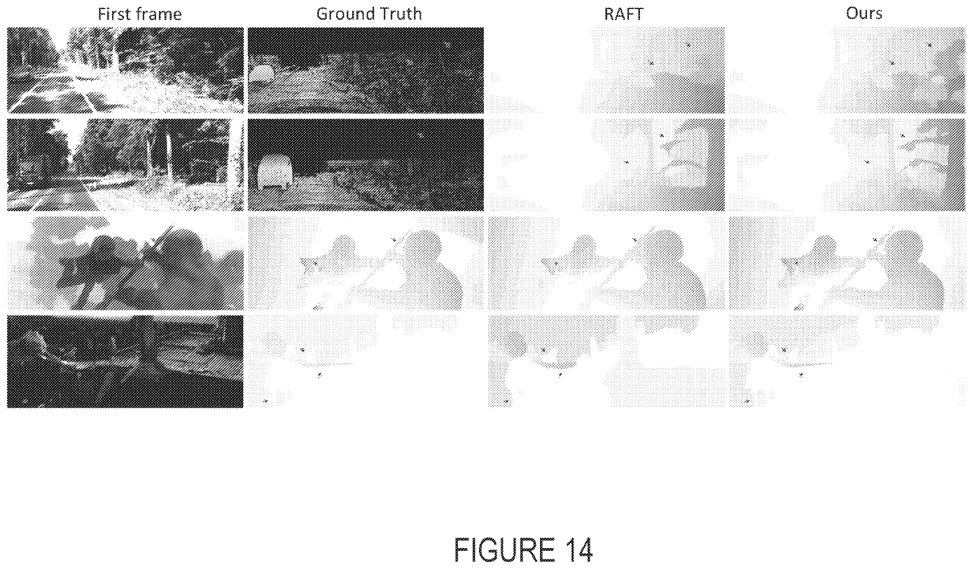

FIG. 14: Visual results comparing RAFT with the method described herein after finetuning. The method described herein does better on fine details and ambiguous regions.

Training high resolution diffusion models is often slow and memory intensive but estimation accuracy has been shown to improve with resolution. A simple solution is to perform inference in a coarse-to-fine manner, first estimating the flow over the entire field of view at low resolution, and then refining the estimates in a patch-wise manner. For refinement the low-resolution map is first up-sampled to the target resolution using bicubic interpolation. Patches are cropped from the up-scaled map, denoted starting at time z, along with the corresponding RGB inputs. Diffusion model inference is then performed with a noisy map y₀~N(yₜ0;\sqrt{y}ₜ0 z, (1−yₜ0)I). For simplicity, to is a fixed hyper-parameter, set based on a validation set. This process is carried out for multiple overlapping patches. The patch estimates are then merged using weighted masks with lower weight near the patch boundaries since predictions at boundaries are more prone to errors.

The denoiser backbone described herein used the Efficient UNet architecture, pretrained with Palette style self-supervised pretraining, and slightly modified to have the appropriate input and output channels for each task. Since diffusion models expect inputs and generate outputs in the range [−1,1], depths were normalized using max depth of 10 meters and 80 meters respectively for the indoor and outdoor models. The optical flow was normalized using the height and width of the ground truth.

Optical flow. Pre-training was performed at a resolution of 320×448 and zero-shot results reported on the widely used Sintel and KITTI datasets. This model was further fine-tuned on a mixture consisting of AutoFlow, FlyingThings, VIPER, HDIK, Sintel, and KITTI at a resolution of 320×768. An average end-point error (AEPE) metric was used that calculates L₂ distance between ground truth and prediction. On KITTI, the outlier rate, Fl-all, was also computed, which reports the outlier ratio in % among all pixels with valid ground truth, where an estimate is considered as an outlier if its error exceeds 3 pixels and 5% w.r.t. the ground truth.

Depth. Indoor and outdoor models were separately pre-trained on the respective pre-training datasets. The indoor depth model was then finetuned and evaluated on the NYU depth v2 dataset and the outdoor model on the KITTI depth dataset. For both NYU depth v2 and KITTI, the absolute relative error (REL), root mean squared error (RMS), and accuracy metrics (δ₁<1.25) are reported.

TABLE 6
Zero-shot optical flow estimation results on Sintel and KITTI. A new
RAFT baseline was provided using the pre-training mixture proposed herein,
substantially improving the accuracy over the original. The diffusion model
described herein outperformed even this much stronger baseline and achieved
state-of-the-art zero-shot results on Sintel.final and KITTI.

| | | Sintel.clean Sintel.final | | KITTI | |
|---|---|---|---|---|---|
| Model | Dataset | AEPE | | AEPE | Fl-all |
| FlowFormer | Chairs→ Things | 1.01 | 2.40 | 4.09 | 14.72% |
| RAFT | Chairs→ Things | 1.68 | 2.80 | 5.92 | — |
| Perceiver IO | AutoFlow | 1.81 | 2.42 | 4.98 | — |
| RAFT | AutoFlow | 1.74 | 2.41 | 4.18 | 13.419% |
| RAFT (ours) | AF→AF + FT + KU + TA | 1.27 | 2.28 | 2.71 | 9.16% |
| Ours | AF→AF + FT + KU + TA | 1.24 | 2.00 | 2.19 | 7.58% |

TABLE 7
Optical flow finetuning evaluation on public benchmark
datasets (AEPE↓ for Sintel and Fl-all↓ for KITTI).
Bold indicates the best and underline the 2^{nd}-best.

| Method | Sintel.clean | Sintel.final | KITTI |
|---|---|---|---|
| SKFlow [70]^{*} | 1.30 | 2.26 | 4.84% |
| CRAFT [64]^{*} | 1.44 | 2.42 | 4.79% |
| FlowFormer [21] | 1.14 | 2.18 | 4.68% |
| RAFT-OCTC [27 | 1.51 | 2.57 | 4.33% |
| RAFT-it [68]^{§} | 1,55 | 2.90 | 4.31% |
| Ours^{§} | 1.75 | 2.48 | 3.26% |

^{§}used extra datasets (AutoFlow and VIPER) on top of defaults (FlyingThings, HD1K, KITTI, and Sintel). *used warm start on Sintel

TABLE 8
Performance comparison on the NYU-Depth-v2 and KITTI datasets.

| | | | NYU-Depth-v2 | | | KITTI | | |
|---|---|---|---|---|---|---|---|---|
| Method | | Architecture | δ₁ ↑ | REL↓ | RMS↓ | δ₁ ↑ | REL↓ | RMS↓ |
| TransDepth [85] | | Res-50 + ViT-B^{†} | 0.900 | 0.106 | 0.365 | 0.956 | 0.064 | 2.755 |
| DPT [48] | | Res-50 + ViT-B^{†‡} | 0.904 | 0.110 | 0.357 | 0.959 | 0.062 | 2.573 |
| BTS [32] | | DenseNet-161^{†} | 0.885 | 0.110 | 0.392 | 0.956 | 0.059 | 2.756 |
| AdaBins [3] | | E-B5 + Mini-ViT^{†} | 0.903 | 0.103 | 0.364 | 0.964 | 0.058 | 2.360 |
| BinsFormer [33] | | Swin-Large^{†} | 0.925 | 0.094 | 0.330 | 0.974 | 0.052 | 2.098 |
| PixelFormer [1] | | Swin-Large^{†} | 0.929 | 0.090 | 0.322 | 0.976 | 0.051 | 2.081 |
| MIM [78] | | SwinV2-L^{T} | 0.949 | 0.083 | 0.287 | 0.977 | 0.050 | 1.966 |
| AiT-P [44] | | SwinV2-L^{T} | 0.953 | 0.076 | 0.279 | — | — | — |
| Ours | samples = 1 | Efficient U-Net^{T‡} | 0.944 | 0.075 | 0.324 | 0.964 | 0.056 | 2.700 |
| | samples = 2 | Efficient U-Net^{T‡} | 0.944 | 0.074 | 0.319 | 0.965 | 0.055 | 2.660 |
| | samples = 4 | Efficient U-Net^{T‡} | 0.946 | 0.074 | 0.315 | 0.965 | 0.055 | 2.613 |

> indicates method used unsupervised pretraining,
^{†}indicates supervised pretraining and
^{‡}indicates use of auxilliary supervised depth data.
Best/second best_results are bolded/underlined respectively.
↓lower is better
↑: higher is better.

Depth. Table 8 reports the results on NYU depth v2 and KITTI. State-of-the-art absolute relative error of 0.074 was achieved on NYU depth v2. On KITTI, the method described herein performed competitively with prior work. Results are reported with averaging depth maps from one or more samples. Note that most prior works use post processing that averages two samples, one from the input image, and the other based on its reflection about the vertical axis.

Flow. Table 6 reports the zero-shot results of the model described herein on Sintel and KITTI training datasets where ground truth is provided. The model was trained on the pre-training mixtures described herein (AutoFlow (AF), FlyingThings (FT), Kubric (KU), and TartanAir (TA)). For a fair comparison, RAFT was re-trained on this pre-training mixture; this new RAFT model significantly outperformed the original RAFT model. The diffusion model described herein outperformed this stronger RAFT baseline. It achieved the state-of-the-art zero-shot results on both the challenging Sintel Final and KITTI datasets.

FIG. 9 provides a qualitative comparison of pre-trained models. The method described herein demonstrated finer details on both object and motion boundaries. Especially on KITTI, the model described herein recovered fine details remarkably well, e.g. on trees and layered motion between tree and background.

TABLE 9
Ablation on infilling and step-unrolling. Without
either one, performance deteriorates. Without both,
optical flow models fail to train on KITTI

| | NYU val | | KITTI val | | KITTI val | |
|---|---|---|---|---|---|---|
| | REL | RMS | REL | RMS | AEPE | Fl-all |
| Baseline | 0.079 | 0.331 | 0.222 | 3.770 | — | — |
| Step-unroll | 0.076 | 0.324 | 0.085 | 2.844 | 1.84 | 6.16% |
| Infill | 0.077 | 0.338 | 0.057 | 2.744 | 1.53 | 5.24% |
| Step-unroll & infill | 0.075 | 0.324 | 0.056 | 2.700 | 1.47 | 4.74% |

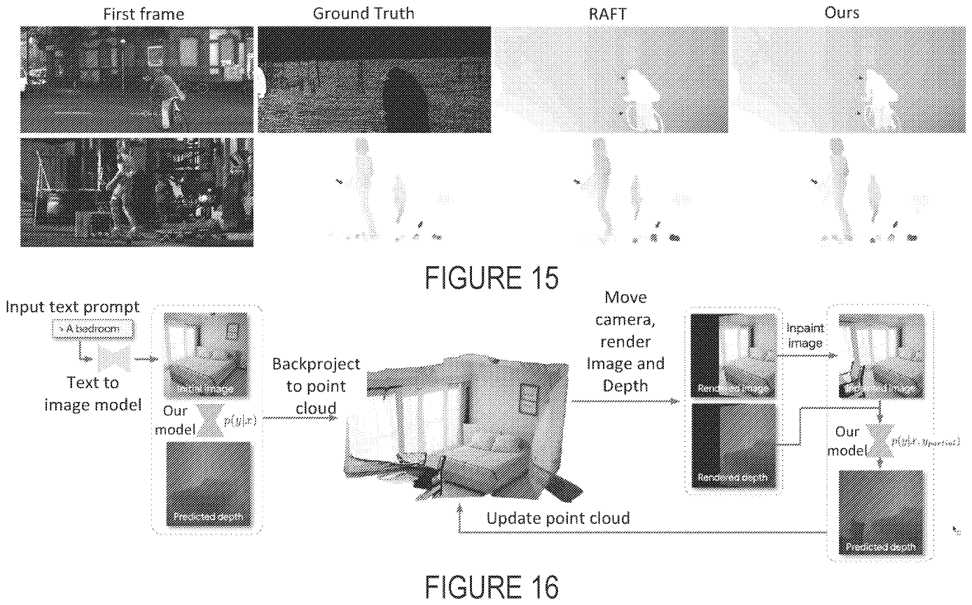

TABLE 10
Coarse-to-fine refinement improves
zero-shot optical flow estimation
results on Sintel and KITTI, along with the
qualitative improvements shown in FIG. 15.

| Coarse-to-fine | Sintel.clean | Sintel.final | KITTI | |
|---|---|---|---|---|
| refinement | AEPE | AEPE | AEPE | Fl-all |
| Without | 1.42 | 2.12 | 2.35 | 8.65% |
| With | 1.24 | 2.00 | 2.19 | 7.58% |

TABLE 11
The addition of optical flow synthetic datasets substantially
improved the zero-shot results on Sintel and KITTI.

| Dataset | Sintel.clean | Sintel.final | KITTI | KITTI Fl-all |
|---|---|---|---|---|
| AF pretraining | 2.04 | 2.55 | 4.47 | 16.59% |
| AF→AF + FT | 1.48 | 2,22 | 3.71 | 14.07% |
| AF→AF + FT + KU + TA | 1.33 | 2.04 | 2.82 | 9.27% |
| AF→AF + FT + KU + TA | 1.24 | 2.00 | 2.19 | 7.58% |

TABLE 12
The addition of synthetic depth data in pre-training
substantially improved fine-tuning performance on NYU.

| Dataset | REL | RMS |
|---|---|---|
| SceneNet RGB-D | 0.089 | 0.362 |
| ScanNet | 0.081 | 0.346 |
| SceneNet RGB-D + ScanNet | 0.075 | 0.324 |

The model described herein was further fin-tuned on the mixture of the AutoFlow, FlyingThings, HDIK, KITTI, Sintel, and VIPER datasets. Table 7 reports the comparison to state-of-the-art optical flow methods on public benchmark datasets, Sintel and KITTI. On KITTI, the method described herein outperformed all existing optical flow methods by a substantial margin (even most scene flow methods that use stereo inputs), and set the new state of the art. On the challenging Sintel final, the method described herein was competitive with other state of the art models. Except for methods using warm-start strategies, the method described herein was only behind FlowFormer, which adopts strong domain knowledge on optical flow (e.g. cost volume, iterative refinement, or attention layers for larger context) unlike the more generic model described herein. On KITTI, however, the diffusion model described herein outperformed FlowFormer by a large margin (30.34%).

### Ablation Studies:

Infilling and step-unrolling. The effect of infilling and step-unrolling are shown in Table 9. For depth, results for fine-tuning the pre-trained model on the NYU and KITTI datasets are reported with the same resolution and augmentations as the best results. For flow, a new model was trained on the KITTI training set alone (with nearest neighbor resizing to the target resolution being the only augmentation) at a resolution of 320×448 and metrics reported on the KITTI val set. Results are reported with a single sample and no coarse-to-fine refinement. Training on raw sparse data without infilling and step unrolling lead to poor results, especially on KITTI where the ground truth is quite sparse. Step-unrolling helped to stabilize training without requiring any extra data pre-processing. The greatest gains came from interpolating missing values in the sparse labels. Infilling and step-unrolling composed well as the best results used both; infilling (being an approximation) does not completely bridge the training-inference distribution shift of the noisy latent.

Coarse-to-fine refinement. FIG. 15 shows that coarse-to-fine refinement substantially improved fine-grained details in estimated optical flow fields. It also improved the metrics for zero-shot optical flow estimation on both KITTI and Sintel, as shown in Table 10.

FIG. 15: Visual results with and without coarse-to-fine refinement. For the pretrained model described herein, refinement helped correct wrong flows and added details to correct flows.

FIG. 16: Application of zero-shot depth completion with the model described herein by incorporating it into an iterative 3D scene generation pipeline. Starting with an initial image (optionally generated from a text-to-image model), an image-only conditioned depth map was sampled using the model described herein. The image-depth pair was added to a point cloud. Images and depth maps (with holes) were then iteratively rendered from this point cloud by moving the camera. Image holes were filled using an existing image inpainter (optionally text conditioned), and then the model described herein was used with replacement guidance to impute missing depths (conditioned on the filled RGB image and known depth).

Datasets. When using different mixtures of datasets for pretraining, diffusion models sometimes captured region boundaries and shape at the expense of local textural variation (e.g., see FIG. 12). The model trained solely on AutoFlow tended to provide very coarse flows, and mimicked the object shapes found in AutoFlow. The addition of Flying Things, Kubric, and TartanAir removed this hallucination and significantly improved the fine details in the flow estimates (e.g., shadows, trees, thin structure, and motion boundaries) together with a substantial boost in accuracy (cf. Table 11). Similarly, mixing SceneNet RGB-D, a synthetic dataset, along with ScanNet provided a performance boost for fine-tuning results on NYU depth v2, shown in Table 12.

One strength of diffusion models is their ability to capture complex multimodal distributions. This can be effective in representing uncertainty, especially where there may exist natural ambiguities and thus multiple predictions, e.g. in cases of transparent, translucent, or reflective cases. FIG. 10 presents multiple samples on the NYU, KITTI, and Sintel datasets, showing that the model described herein captures multimodality and provides plausible samples when ambiguities exist.

A diffusion model trained to model the conditional distribution p(y|x) can be zero-shot leveraged to sample from p(y|x,yₚₐᵣₜᵢₐₗ) where yₚₐᵣₜᵢₐₗ is the partially known label. One approach for doing this, known as the replacement method for guidance, is to replace the known portion the latent yₜ at each inference step with the noisy latent built by applying the forward process to the known label. The results of leveraging replacement guidance for depth completion were investigated and it was found to be very effective. This was illustrated by building a pipeline for iteratively generating 3D scenes (conditioned on a text prompt) as shown in FIG. 16 by leveraging existing models for text-to-image generation and text-conditional image inpainting.

### Third Experiments

Prior knowledge of distinct indoor and outdoor datasets (e.g., NYU for indoor and KITTI for outdoor) is not necessary to generate a competent diffusion model to predict depth maps, conditioned on input RGB images, for both indoor and outdoor scenes. Models as described herein can exploit learned priors over the sizes of the objects, for example, to resolve ambiguities for general scenes with large amounts of depth variation. These benefits are accessible by using a greater diversity of input training data, through a combination of augmentations and real training data to allow models to learn to generalize to a wide range of camera intrinsics (e.g., field of view (FOV)) rather than over-fitting to intrinsics that are often fixed within common benchmark datasets.

Models that implement Diffusion for Metric Depth (DMD) are provided herein that make use of image to image diffusion models for solving zero-shot metric depth estimation. Such models have been effective for several vision tasks without the need for task-specific models. Diffusion models have also been shown to capture the uncertainty in the depth estimate and enable zero-shot depth completion. This motivates their use for metric depth.

The subject matter of the present disclosure provides a number of benefits:

A simple model for joint indoor-outdoor that includes a generic diffusion model rather than task- or domain-specific architectures such as binning or mixture-experts with separate heads for indoor and outdoor.

A zero-shot model-no need for domain-specific fine-tuning as is common (e.g. with KITTI and NYU).

Improved training: 1) Log depth to amplify indoor depth and better handle large changes in depth distributions of indoor and outdoor datasets; 2) a crop-uncrop augmentation scheme to augment training data with more diverse field-of-view (FoV) than the original training data with fixed FoV.

Models as described herein experimentally outperformed ZoeDepth on OOD datasets and exhibited high effectiveness with very few inference steps. Performance improved significantly with more training data than is commonly used.

TABLE 13
Quantitative results for zero-shot transfer to four unseen indoor datasets. Evaluation depth was capped at
8 m for SUN RGB-D, 10 m for iBims and DIODE Indoor, and 80 m for HyperSim. Best and second-best results are
highlighted, with the former additionally bolded. Following pre-training, DMD-NK was trained on the union
of NYUv2 and KITTI, while DMD-MIX added Taskonomy and NuScenes to the training data. Fine-tuned on the same
data, DMD-NK outperformed ZoeD-M12-NK. With more data, DMD-MIX outperformed by an even larger margin.

| | SUN RGB-D | | | iBims-1 Benchmark | | | DIODE Indoor | | | HyperSim | | |
|---|---|---|---|---|---|---|---|---|---|---|---|---|
| Method | δ₁ ↑ | REL ↓ | RMSE↓ | δ₁ ↑ | REL ↓ | RMSE↓ | δ₁ ↑ | REL ↓ | RMSE↓ | δ₁ ↑ | REL ↓ | RMSE↓ |
| BTS [27] | 0.740 | 0.172 | 0.515 | 0.538 | 0.231 | 0.919 | 0.210 | 0.418 | 1.905 | 0.225 | 0.476 | 6.404 |
| AdaBins [2] | 0.771 | 0.159 | 0.476 | 0.555 | 0.212 | 0.901 | 0.174 | 0.443 | 1.963 | 0.221 | 0.483 | 6.546 |
| LocalBins [3] | 0.777 | 0.156 | 0.470 | 0.558 | 0.211 | 0.880 | 0.229 | 0.412 | 1.853 | 0.234 | 0.468 | 6.362 |
| NeWCRFs [42] | 0.798 | 0.151 | 0.424 | 0.548 | 0.206 | 0.861 | 0.187 | 0.404 | 1.867 | 0.255 | 0.442 | 6.017 |
| ZoeD-M12-NK | 0.856 | 0.123 | 0.356 | 0.615 | 0.186 | 0.777 | 0.386 | 0.331 | 1.598 | 0.274 | 0.419 | 5.830 |
| DMD-NK | 0.914 | 0.109 | 0.306 | 0.801 | 0.130 | 0.563 | 0.402 | 0.298 | 1.407 | 0.356 | 0.382 | 5.527 |
| DMD-MIX | 0.930 | 0.091 | 0.275 | 0.859 | 0.118 | 0.447 | 0.380 | 0.291 | 1.292 | 0.497 | 0.318 | 4.394 |

TABLE 14
Quantitative results for zero-shot transfer to four unseen outdoor datasets. Best and second-
best results are highlighted, with the former additionally bolded. Following pre-training,
DMD-NK was trained on NYUv2 and KITTI, while DMD-MIX added Taxonomy and NuScenes for training.
Using the same fine-tuning data, DMD-NK outperformed ZoeD-M12-NK on all benchmarks except
DIODE Outdoor where it outperformed on REL but was behind on other metrics. DMD-MIX showed
further performance improvements over DMD-NK with the expanded training mixture.

| | Virtual KITTI 2 | | | DDAD | | | DIML Outdoor | | | DIODE Outdoor | | |
|---|---|---|---|---|---|---|---|---|---|---|---|---|
| Method | δ₁ ↑ | REL ↓ | RMSE↓ | δ₁ ↑ | REL ↓ | RMSE↓ | δ₁ ↑ | REL ↓ | RMSE↓ | δ₁ ↑ | REL ↓ | RMSE↓ |
| BTS [27] | 0.831 | 0.115 | 5.368 | 0.805 | 0.147 | 7.550 | 0.016 | 1.785 | 5.908 | 0.171 | 0.837 | 10.48 |
| AdaBins [2] | 0.826 | 0.122 | 5.420 | 0.766 | 0.154 | 8.560 | 0.013 | 1.941 | 6.272 | 0.161 | 0.863 | 10.35 |
| LocalBins [3] | 0.810 | 0.127 | 5.981 | 0.777 | 0.151 | 8.139 | 0.016 | 1.820 | 6.706 | 0.170 | 0.821 | 10.27 |
| NeWCRFs [42] | 0.829 | 0.117 | 5.691 | 0.874 | 0.119 | 6.183 | 0.010 | 1.918 | 6.283 | 0.176 | 0.854 | 9.228 |
| ZoeD-M12-NK | 0.850 | 0.105 | 5.095 | 0.824 | 0.138 | 7.225 | 0.292 | 0.641 | 3.610 | 0.208 | 0.757 | 7.569 |
| DMD-NK | 0.872 | 0.093 | 4.828 | 0.842 | 0.122 | 6.740 | 0.544 | 0.300 | 2.522 | 0.162 | 0.627 | 9.577 |
| DMD-MIX | 0.890 | 0.092 | 4.387 | 0.907 | 0.108 | 5.365 | 0.602 | 0.190 | 2.089 | 0.187 | 0.553 | 8.943 |

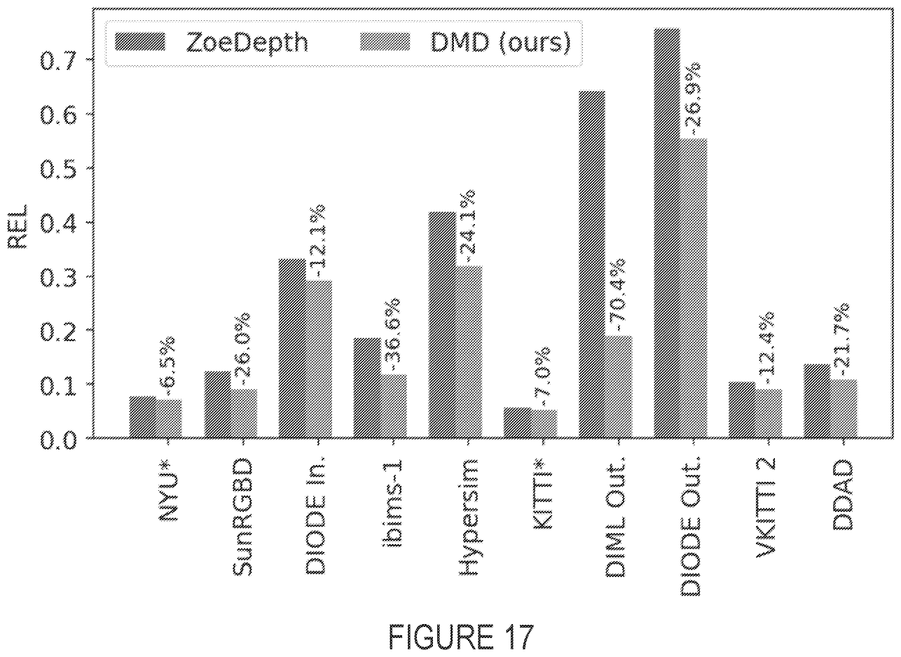

FIG. 17: Relative depth error (RELI) for the method described herein compared to ZoeDepth on eight zero-shot and two in-domain (*) benchmarks, indoor on the left side of the plot, and outdoor on the right. The method described herein, DMD, outperformed ZoeDepth by a substantial margin on all benchmarks.

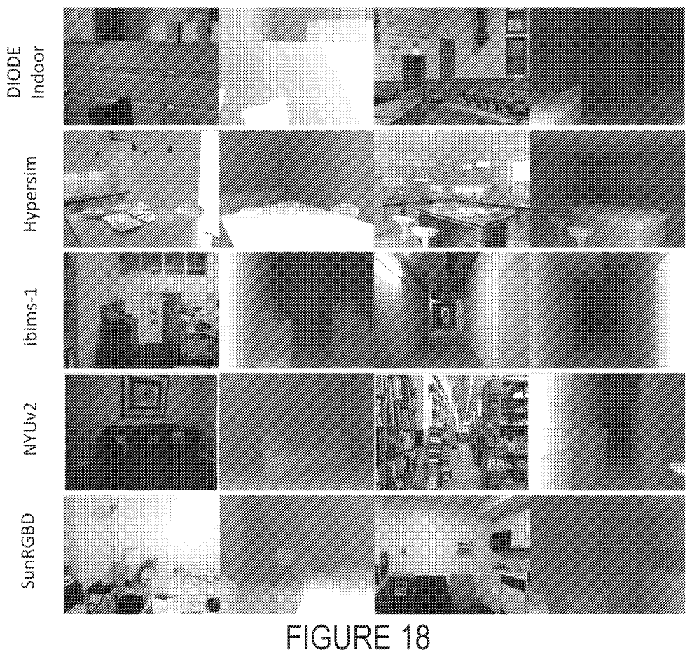

FIG. 18: Qualitative examples of the method described herein on multiple indoor datasets.

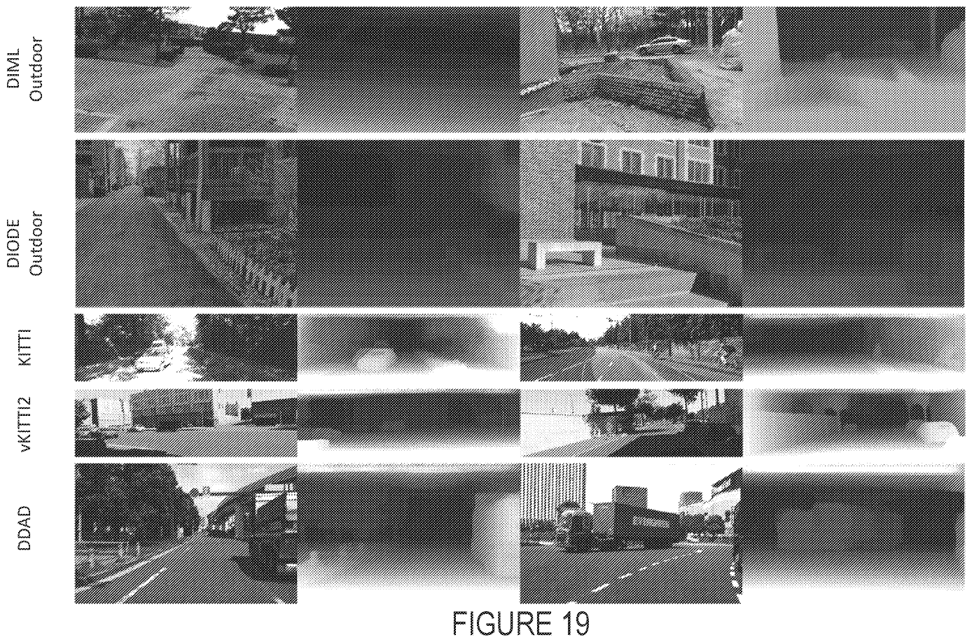

FIG. 19: Qualitative examples of the method described herein on multiple outdoor datasets.

As discussed above, key challenges in metric depth estimation stem from depth-scale ambiguities and the substantial differences between indoor and outdoor data. As such, previous methods have focused on scale- and shift-invariant depth estimation, or on separate models for indoor and outdoor with fixed camera intrinsics. The present disclosure describes a diffusion model with design decisions aimed to solve these issues. In particular, monocular depth estimation is cast as a generative RGB-to-depth translation task using denoising diffusion. To this end several modifications to conventional diffusion models and training procedures thereof are provided to accommodate zero-shot, metric depth.

Contrary to DDVM, the embodiments described herein model depth in the log scale to adequately allocate modelling capacity for indoor and outdoor scenes. Additionally, using v-parameterization instead of x- or ε-parameterization (used in DDVM) lead to a more efficient denoiser that was capable of denoising using fewer steps. Field-of-view augmentations through cropping/uncropping and conditioning on the field-of-view also allows models to mitigate the scale ambiguity problem. While the models herein trained on NYU and KITTI alone already outperformed current SOTA for zero-shot metric depth estimation, diversifying the fine-tuning mixture further improved performance.

Diffusion models presume a process that gradually transforms a target distribution into a tractable noise distribution, for which a neural denoising network is learned to reverse this process, slowly converting a noise sample to a sample from the target distribution. They have been shown to be remarkably effective with images and video, and they have recently begun to see use for dense vision tasks like segmentation, tracking, optical flow, and depth estimation. They are attractive as they exhibit strong performance on regression tasks, capturing posterior uncertainty, without task specific architectures, loss functions, and training procedures.

The v-paramterization was used with a truncated SNR weighted loss with a L1 norm, motivated by the finding that training with L1 often outperforms L2 with an ε-parameterization. In particular, the following loss was used:

$$Loss = max ( {‖ x - {\hat{x}}_{t} ‖}_{1}^{1} , {‖ ϵ - {\hat{ϵ}}_{t} ‖}_{1}^{1} ) \qquad ( 1 )$$

Training a joint indoor-outdoor model can be difficult because of the large differences in depth distributions found between indoor and outdoor scenes. Much of the available indoor training data have depths up to 10 m, while outdoor scenes include ground truth depths up to 80 m. Further, training data often lacks the variation in camera intrinsics and fields of view needed for robustness to images from different cameras. Rather, many datasets are captured with a fixed camera. To mitigate these issues, three improvements are provided: the use of log depth, field of view augmentation, and field of view conditioning.

### Log Depth.

Diffusion models usually model data distribution in [−1,1]. One might convert metric depth to this range with linear scaling, e.g.,

$${d}_{lin} = normalize ( {d}_{r} / {d}_{max} ) \qquad ( 2 )$$

where dᵣ is the raw depth in meters, dₘₐₓ can be taken to be 80 m, to accommodate the usual outdoor depth range, and normalize (d)=clip(2*d−1, −1,1). This, however, allocates little representation capacity to indoor scenes (usually less than 10 m).

Instead, more representation capacity can be allocated to indoor scenes with log-scaled depth (d_{log}) as the target for inference, e.g.,

$${d}_{\text{?}} = normalize ( \frac{log ( \text{?} / {d}_{\text{?}} )}{log ( {d}_{\text{?}} / {d}_{\text{?}} )} ) \qquad ( 3 )$$

$$\text{?} \text{indicates text missing or illegible when filed}$$

where dₘᵢₙ and dₘₐₓ denote the minimum and maximum supported depths (e.g., 0.5 m and 80 m). Empirically, log scaling was found to be remarkably beneficial.

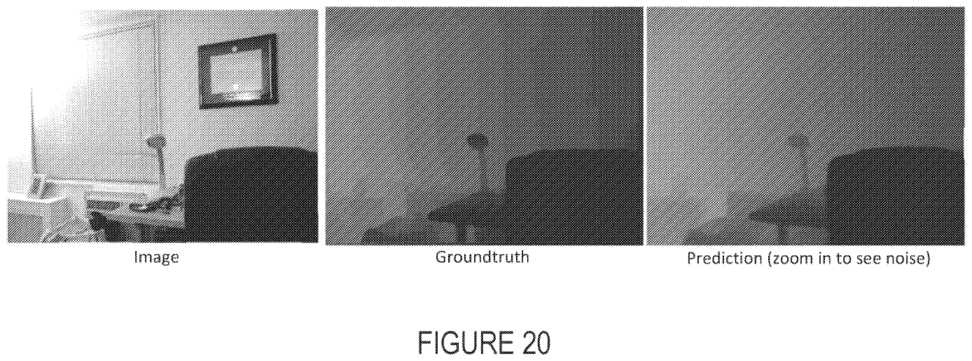

Table 15 and FIG. 20 illustrate this, showing improved quantitative and qualitative performance on indoor scenes with log depth rather than linear depth scaling.

Field-of-view augmentation. Because datasets for depth estimation often have little or no variation in the field of view it is easy for models to over-fit, and then generalize poorly to other camera intrinsics. To encourage models to generalize well to different fields of view, training data can be augmented by cropping or uncropping to simulate diverse FOVs. While cropping is straightforward, for uncropping the enlarged image can be padded in a variety of ways. Preliminary experiments used generative uncropping with Palette, however, simply padding the RGB image with Gaussian noise (white, mean zero, variance 1) was experimentally found to work as well while requiring less compute.

For missing ground truth depth with uncropping augmentation, a combination of near-neighbor in-filling and step-unrolled denoising during training was used. This technique is effective in coping with the inherent distribution shift between training and testing when ground truth data are noisy or incomplete.

Field-of-view conditioning. Because of depth-scale ambiguity one needs other information. This can include conditioning the model on the FOV of the input image. Two scenarios were evaluated, one in which prior knowledge of camera intrinsics is available, as might be the case in autonomous driving or robots, and one in which an image having no available metadata or other associated FOV information, in which case one may predict FOV from the image.

Augmenting the FOV of the training data may not be sufficient for making the model robust to changes in FOV; conditioning on the FOV greatly improved results. tan (0/2) was used as the conditioning input to the model, where 0 is the vertical FOV. Additionally conditioning on the horizontal FOV was investigated, but that did not improve results further.

DDVM showed that the using large amounts of diverse training data is especially important for generic models with no task specific inductive biases. The model described herein was initialized with unsupervised pre-training on the ImageNet and Places365 datasets using a variety of tasks proposed in. For the supervised pre-pretraining stage ScanNet and SceneNet-RGBD were used for indoor training data and Waymo Open Dataset was used for outdoor training dataset with the addition of the DIML Indoor dataset for further diversity. Note that FOV augmentation or conditioning were note used at this stage. For the final fine-tuning stage two models were trained. The main model was trained on a mixture of the NYU, Taskonomy, KITTI, and NuScenes datasets. However, for a fair comparison with the current SOTA, ZoeDepth, another model was trained on NYU and KITTI alone. The FOV augmentation was applied to NYU, KITTI, and NuScenes. Since Taskonomy already has images with diverse FOV further FOV augmentations were not used for it.

The modified version of the Efficient U-Net architecture proposed in DDVM was used as the neural denoiser. The architecture was modified to support FOV conditioning. In particular, the FOV embedding was constructed in a fashion similar to the timestep embedding by first building a sin-cos positional embedding followed by a linear projection. This embedding was added to the timestep embedding and the sum used to modulate different layers of the denoiser backbone using FiLM layers. Training was performed at a resolution of 384×512. The predicted depth maps were resized to the ground truth resolution for evaluation.

FIG. 20: Linearly scaling depth leads to noisy predictions for images with shallow depth.

TABLE 15
Ablation showing that log depth improved quantitative performance. This particularly impacted datasets with shallower depths,
e.g., the indoor datasets and DIML Outdoor which, despite being an outdoor dataset, has relatively shallow depth.

| | Indoors | | | | | Outdoors | | | | |
|---|---|---|---|---|---|---|---|---|---|---|
| Experiment | NYU | SunRGBD | DIODE Indoor | ibims- 1 | Hypersim | KITTI | DIML Outdoor | DIODE Outdoor | Virtual KITTI 2 | DDAD |
| Linear scaling | 0.082 | 0.108 | 0.324 | 0.146 | 0.398 | 0.056 | 0.467 | 0.630 | 0.092 | 0.122 |
| Log scaling | 0.076 | 0.109 | 0.298 | 0.130 | 0.382 | 0.055 | 0.300 | 0.628 | 0.093 | 0.122 |

TABLE 16
Ablation showing relative error for models trained with and without field-of-view conditioning.
Simply augmenting the field-of-view at training was insufficient to make the model robust
to changes in field-of-view and conditioning on the field-of-view was also required.

| | Indoors | | | | | Outdoors | | | | |
|---|---|---|---|---|---|---|---|---|---|---|
| | | | DIODE | | | | DIML | DIODE | Virtual | |
| Experiment | NYU | SunRGBD | Indoor | ibims-1 | Hypersim | KITTI | Outdoor | Outdoor | KITTI 2 | DDAD |
| No FOV cond | 0.081 | 0.116 | 0.316 | 0.18 | 0.400 | 0.057 | 1.257 | 0.613 | 0.100 | 0.121 |
| With FOV cond | 0.076 | 0.109 | 0.298 | 0.130 | 0.382 | 0.055 | 0.300 | 0.628 | 0.093 | 0.122 |

In addition to the FOV augmentation, random horizontal flip augmentation was used.

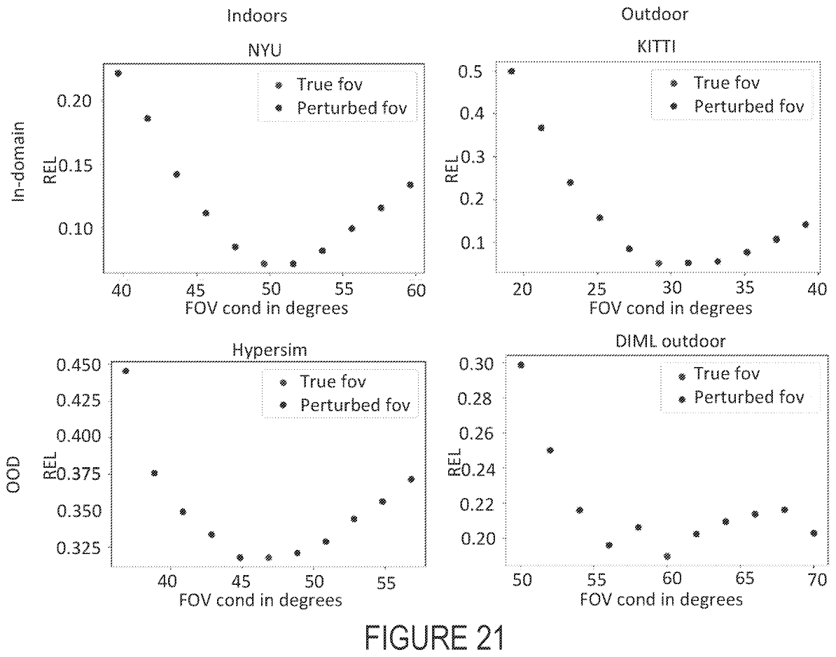

FIG. 21: Plots showing the effect of perturbing the FOV during inference. Optimal performance was at or near the true FOV. Performance degraded with larger perturbations.

The DDPM sampler was used with eight denoising steps for indoor datasets and two denoising steps for outdoor datasets. Results are reported using a mean of eight samples.

As shown in Table 21, sample averaging lead to a small improvement in performance.

Tables 13 and 14 report zero-shot performance on eight datasets. For a fair comparison with ZoeDepth, a model was finetuned on NYU and KITTI only (dubbed DMD-NK). This model outperformed ZoeDepth across all datasets except DIODE Outdoor where the model outperformed ZoeDepth on relative error but was behind on RMSE and δ1.

Further improvements in performance were readily available by fine-tuning on larger datasets. The variant model trained on a mixture with KITTI, NYU, NuScene, and Taskonomy (dubbed DMD-MIX), for example, generalized much better on OOD test data, establishing a stronger, new state of the art.

Tables 19 and 20 show results on the NYU and KITTI datasets respectively. The model described herein outperformed ZoeDepth on relative error and was competitive on other metrics. DMD-MIX also outperformed DMD-NK on in-domain data.

For compute efficiency and expedience, ablations were performed only on DMD-NK.

Log vs linearly scaled depth. Table 15 shows that modeling depth in log scale improved quantitative performance, especially on datasets with shallow depth. Furthermore, as shown in FIG. 20, using linear-scaling lead to noise artifacts in the depth estimates for indoor scenes.

Field-of-view conditioning. Conditioning on the FOV was necessary for achieving the best performance. Simply augmenting the dataset with FOV augmentations (baseline) did not result in the greatest performance. FIG. 21 perturbs the conditioning FOV at inference and finds that the optimal performance occurred at or close to the true FOV.

TABLE 17
Comparison against ZoeDepth without scene type supervision.
ZoeDepth performance degraded significantly when the scene
type (indoor or outdoor) was not provided. The models
escribed herein learned well without such supervision.

| | REL ↓ | | RMSE ↓ | |
|---|---|---|---|---|
| | NYU | KITTI | NYU | KITTI |
| ZoeDepth Auto Router | 0.102 | 0.075 | 0.377 | 2.584 |
| Ours no fov aug / cond | 0.074 | 0.055 | 0.310 | 2.597 |

No FOV augmentation or conditioning. ZoeDepth found that without scene-type supervision on the experts (dubbed Auto Router), their model's performance degraded even in-domain. To compare against ZoeDepth in this setting, a model was finetuned on NYU and KITTI without FOV augmentations or conditioning. This model performed very well in this setting in-domain (Table 17). However, the out-of-domain performance still lagged behind the model with FOV augmentation and conditioning.

∈ vs δ diffusion parameterization. Using v parameterization dramatically reduced the number of denoising steps required to achieve good performance. As shown in Table 18, ∈-parameterization required 64 denoising steps to perform competitively with a v-parameterized model using a single denoising step.

TABLE 18
Comparison of relative error on the NYU and
KITTI datasets for models trained with ε-
and ν-parameterization of diffusion.
Both models were fine tuned on
NYU and KITTI only without FOV
augmentation or conditioning.

| Num | | | | |
|---|---|---|---|---|
| denoising | NYU | | KITTI | |
| steps | ε | ν | ε | ν |
| 1 | 2.374 | 0.077 | 0.596 | 0.056 |
| 4 | 1.484 | 0.075 | 0.406 | 0.055 |
| 16 | 0.409 | 0.074 | 0.141 | 0.055 |
| 64 | 0.077 | 0.074 | 0.056 | 0.055 |

TABLE 19
Quantitative comparison on NYU-Depth v2. The reported numbers
of the prior art are from the corresponding original papers.
Best results are in bold, second best are underlined.

| Method | δ₁ ↑ | δ₂ ↑ | δ₃ ↑ | REL ↓ | RMSE ↓ | log₁₀ ↓ |
|---|---|---|---|---|---|---|
| Eigen et al. [12] | 0.769 | 0.950 | 0.988 | 0.158 | 0.641 | — |
| Laina et al. [25] | 0.811 | 0.953 | 0.988 | 0.127 | 0.573 | 0.055 |
| Hao et al. [17] | 0.841 | 0.966 | 0.991 | 0.127 | 0.555 | 0.053 |
| DORN [14] | 0.828 | 0.965 | 0.992 | 0.115 | 0.509 | 0.051 |
| SharpNet [31] | 0.836 | 0.966 | 0.993 | 0.139 | 0.502 | 0.047 |
| Hu et al. [21] | 0.866 | 0.975 | 0.993 | 0.115 | 0.530 | 0.050 |
| Lee et al. [26] | 0.837 | 0.971 | 0.994 | 0.131 | 0.538 | — |
| Chen et al. [8] | 0.878 | 0.977 | 0.994 | 0.111 | 0.514 | 0.048 |
| BTS [27] | 0.885 | 0.978 | 0.994 | 0.110 | 0.392 | 0.047 |
| Yin et al. [41] | 0.875 | 0.976 | 0.994 | 0.108 | 0.416 | 0.048 |
| AdaBins [2] | 0.903 | 0.984 | 0.997 | 0.103 | 0.364 | 0.044 |
| LocalBins [3] | 0.907 | 0.987 | 0.998 | 0.099 | 0.357 | 0.042 |
| Jun et al. [24] | 0.913 | 0.987 | 0.998 | 0.098 | 0.355 | 0.042 |
| NeWCRFs [42] | 0.922 | 0.992 | 0.998 | 0.095 | 0.334 | 0.041 |
| ZoeD-M12-NK | 0.953 | 0.995 | 0.999 | 0.077 | 0.277 | 0.033 |
| DMD-NK | 0.944 | 0.986 | 0.996 | 0.076 | 0.313 | 0.033 |
| DMD-MIX | 0.953 | 0.989 | 0.996 | 0.072 | 0.296 | 0.031 |

While RGB camera intrinsics are available for most practical uses of monocular depth estimators (e.g. cell phones, robot platforms or self-driving cars), they may sometimes be unknown (e.g. internet images or generative imagery). For those, a FOV estimator may be used. A naive FOV predictor works well and is competitive with results using true FOV.

TABLE 20
Comparison of performance on the KITTI dataset.

| Method | δ₁ ↑ | δ₂ ↑ | δ₃ ↑ | REL ↓ | Sq-rel ↓ | RMS ↓ | RMS log ↓ |
|---|---|---|---|---|---|---|---|
| BTS [27] | 0.956 | 0.993 | 0.998 | 0.059 | 0.245 | 2.756 | 0.096 |
| TransDepth [44] | 0.956 | 0.994 | 0.999 | 0.064 | 0.252 | 2.755 | 0.098 |
| DPT [33] | 0.959 | 0.995 | 0.999 | 0.062 | — | 2.573 | 0.092 |
| AdaBins [2] | 0.964 | 0.995 | 0.999 | 0.058 | 0.190 | 2.360 | 0.088 |
| BinsFormer [28] | 0.974 | 0.997 | 0.999 | 0.052 | 0.151 | 2.098 | 0.079 |
| PixelFormer [1] | 0.976 | 0.997 | 0.999 | 0.051 | 0.149 | 2.081 | 0.077 |
| MIM [40] | 0.977 | 0.998 | 1.000 | 0.050 | 0.139 | 1.966 | 0.075 |
| DDVM [37] | 0.965 | 0.994 | 0.998 | 0.055 | 0.292 | 2.613 | 0.089 |
| ZoeD-M12-NK [4] | 0.966 | 0.993 | 0.996 | 0.057 | 0.204 | 2.362 | 0.087 |
| DMD-NK | 0.964 | 0.994 | 0.999 | 0.055 | 0.219 | 2.527 | 0.087 |
| DMD-MIX | 0.967 | 0.995 | 0.999 | 0.053 | 0.203 | 2.411 | 0.084 |

> indicates method uses unsupervised pretraining,
† indicates supervised pretraining and
‡ indicates use of auxiliary supervised depth data.
Best/second best results are bolded/underlined respectively.
↓: lower is better and
↑: higher is better.

TABLE 21
Averaging multiple samples leads to small but consistent improvement on both REL and RMS.

| | | Indoors | | | | | Outdoors | | | | |
|---|---|---|---|---|---|---|---|---|---|---|---|
| | | | | DIODE | | | | DIML | DIODE | Virtual | |
| Metric | # samples | NYU | SunRGBD | Indoor | ibims-1 | Hypersim | KITTI | Outdoor | Outdoor | KITTI 2 | DDAD |
| REL | 1 | 0.077 | 0.11 | 0.304 | 0.135 | 0.383 | 0.055 | 0.311 | 0.634 | 0.093 | 0.122 |
| | 8 | 0.076 | 0.109 | 0.298 | 0.130 | 0.382 | 0.055 | 0.300 | 0.628 | 0.093 | 0.122 |
| RMS | 1 | 0.321 | 0.311 | 1.426 | 0.579 | 5.521 | 2.544 | 2.572 | 9.602 | 4.842 | 6.755 |
| | 8 | 0.313 | 0.306 | 1.407 | 0.563 | 5.527 | 2.527 | 2.522 | 9.577 | 4.828 | 6.740 |

### VI. Conclusion

The particular arrangements shown in the Figures should not be viewed as limiting. It should be understood that other embodiments may include more or less of each element shown in a given Figure. Further, some of the illustrated elements may be combined or omitted. Yet further, an exemplary embodiment may include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

### VII. Enumerated Example Embodiments

Embodiments of the present disclosure may thus relate to one of the enumerated example embodiments (EEEs) listed below. It will be appreciated that features indicated with respect to one EEE can be combined with other EEEs.

EEE 1 is a computer-implemented method that includes training a machine learning model to predict depth maps for color images via an iterative diffusion inference process, wherein training the machine learning model includes: (i) adding noise to a first depth map to generate a second depth map, wherein the first depth map represents depth across a first scene depicted in a first color image; (ii) applying the first color image and the second depth map to the machine learning model to generate a third depth map; (iii) based on the third depth map, generating a plurality of loss values; and (iv) updating the machine learning model based on the plurality of loss values.

EEE 2 is 1computer-implemented method of EEE 1, further including using the trained machine learning model to predict a first target depth map for a target color image via the iterative diffusion inference process by, for a plurality of iterations: applying the target color image and a respective input depth map estimate to the trained machine learning model to generate a respective output depth map, wherein the input depth map of a first iteration of the plurality of iterations is a randomly or pseudo-randomly generated depth map of noise, wherein the input depth map for each iteration of the plurality of iterations other than the first iteration is the output depth map of an immediately preceding iteration with an amount of noise added thereto, and wherein the first target depth map is the output depth map of a final iteration of the plurality of iterations.

EEE 3 is the computer-implemented method of EEE 2, further comprising generating a novel view of a target scene depicted in the target color image by: (i) using the first target depth map and the target color image to render an alternative color image of the target scene, wherein the alternative color image includes holes representing aspects of the target scene that are occluded from view in the target color image; (ii) using the first target depth map to render an alternative depth map of the target scene as viewed from a perspective of the alternative color image, wherein the alternative depth map includes holes representing aspects of the target scene that are occluded from view in the first target depth map; (iii) filling in the holes of the alternative color image; and (iv) subsequent to filling in the holes of the alternative color image, using the trained machine learning model to fill in the holes of the alternative depth map via the iterative diffusion inference process by, for a plurality of iterations: applying the alternative color image and a respective input depth map estimate to generate a respective output depth map, wherein the input depth map of a first iteration of the plurality of iterations is the alternative depth map with an amount of noise added thereto, and wherein the input depth map for each iteration of the plurality of iterations other than the first iteration is the output depth map of an immediately preceding iteration with an amount of noise added thereto.

EEE 4 is the computer-implemented method of any preceding EEE, wherein generating the plurality of loss values comprises generating a plurality of L1 loss values between the third depth map and the first depth map or between the third depth map and the noise added to the first depth map to generate the second depth map.

EEE 5 is the computer-implemented method of any preceding EEE, further comprising: (1) training a precursor machine learning model to predict restored color images for degraded color images via an iterative diffusion inference process, wherein training the precursor machine learning model comprises: (i) adding noise to a first source color image to generate a second source color image; (ii) applying the second source color image and a third source color image to the precursor machine learning model to generate a fourth source color image, wherein the third source color image is a degraded version of the first source color image that has been degraded by at least one of: (a) being cropped, (b) being decolorized, (c) having had image compression artifacts added thereto, or (d) having had one or more regions of missing pixels added thereto; and (iii) updating the precursor machine learning model based on a plurality of loss values generated based on differences between the fourth source color image and the first source color image; and (2) modifying the precursor machine learning model to receive an input color image and an input depth map and to generate therefrom an output depth map based on the input depth map and conditioned on the input color image, wherein training the machine learning model to predict depth maps for color images via the iterative diffusion inference process comprises using the modified precursor machine learning model as an initial state for the machine learning model.

EEE 6 is the computer-implemented method of EEE 5, wherein modifying the precursor machine learning model to receive an input color image and an input depth map and to generate therefrom an output depth map based on the input depth map and conditioned on the input color image includes: (i) discarding from the precursor machine learning model at least one three-channel input kernel that receives the second source color image and at least one three-channel output kernel that generates the fourth source color image; and (ii) adding and initializing at least one single-channel input kernel that receives the second depth map and at least one single-channel output kernel that generates the third depth map.

EEE 7 is the computer-implemented method of any preceding EEE, wherein the machine learning model has a U-Net architecture.

EEE 8 is the computer-implemented method of any preceding EEE, wherein training the machine learning model further includes: prior to adding noise to the first depth map to generate the second depth map, filling in at least one hole in the first depth map.

EEE 9 is the computer-implemented method of EEE 8, wherein filling in at least one hole in the first depth map comprises filling in pixels of at least one hole in the first depth map using a nearest-neighbor filling method.

EEE 10 is the computer-implemented method of any of EEEs 8-9, wherein filling in at least one hole in the first depth map comprises (i) identifying, based on the first color image, a region of the first depth map that represents a sky and (ii) filling in pixels of the region of the first depth map that represents the sky with a specified depth value.

EEE 11 is the computer-implemented method of any of EEEs 8-10, wherein generating the plurality of loss values based on the third depth map comprises: (i) adding noise to the third depth map to generate a fourth depth map; (ii) applying the first color image and the fourth depth map to the machine learning model to generate a fifth depth map; and (iii) generating the plurality of loss values based on differences between the fifth depth map and the third depth map or between the fifth depth map and the noise added to the third depth map to generate the fourth depth map.

EEE 12 is the computer-implemented method of any of EEEs 1-7, wherein generating the plurality of loss values based on the third depth map comprises: (i) adding noise to the third depth map to generate a fourth depth map; (ii) applying the first color image and the fourth depth map to the machine learning model to generate a fifth depth map; and (iii) generating the plurality of loss values based on differences between the fifth depth map and the third depth map or between the fifth depth map and the noise added to the third depth map to generate the fourth depth map.

EEE 13 is the computer-implemented method of any of EEEs 1-12, wherein training the machine learning model to predict depth maps for color images via the iterative diffusion inference process comprises: training the machine learning model to predict log-distance metric depth maps for color images via the iterative diffusion inference process, wherein the first depth map is a first log-distance depth map, wherein the second depth map is a second log-distance depth map, wherein the first log-distance depth map represents the logarithm of depth across the first scene depicted in the first color image, and wherein the third depth map is a third log-distance depth map.

EEE 14 is the computer-implemented method of EEE 13, wherein training the machine learning model to predict log-distance metric depth maps for color images via an iterative diffusion inference process comprises training the machine learning model to predict log-distance metric depth maps for color images and associated field of view (FOV) measurements for the color images via the iterative diffusion inference process, wherein applying the first color image and the second log-distance depth map to the machine learning model to generate the third log-distance depth map comprises applying the first color image, the second log-distance depth map, and a first FOV measurement to the machine learning model to generate the third log-distance depth map, and wherein the first FOV measurement represents an angular field of view across at least one dimension of the first color image.

EEE 15 is the computer-implemented method of EEE 14, further comprising: (i) training a precursor machine learning model to predict log-distance metric depth maps for color images via an iterative diffusion inference process; and (ii) augmenting the trained precursor machine learning model to receive FOV measurements as inputs in addition to color images and log-distance depth maps, wherein training the machine learning model to predict log-distance metric depth maps comprises training the trained, augmented precursor machine learning model.

EEE 16 is the computer-implemented method of EEE 15, wherein augmenting the trained precursor machine learning model to receive FOV measurements as inputs in addition to color images and log-distance depth maps comprises: (i) adding a sinusoidal positional embedding of the FOV measurement input; and (ii) adding a linear projection of outputs of the sinusoidal positional embedding to one or more layers of the trained precursor machine learning model.

EEE 17 is the computer-implemented method of any of EEEs 14-16, wherein the first FOV measurement represents a tangent function of the angular field of view across at least one dimension of the first color image.

EEE 18 is the computer-implemented method of any of EEEs 14-17, wherein training the machine learning model to predict log-distance metric depth maps for color images and associated field of view (FOV) measurements for the color images via the iterative diffusion inference process comprises training the machine learning model to predict log-distance metric depth maps for color images, associated field of view (FOV) measurements for the color images, and associated noise inputs via the iterative diffusion inference process, wherein applying the first color image, the second log-distance depth map, and the first FOV measurement to the machine learning model to generate the third log-distance depth map comprises applying the first color image, the second log-distance depth map, the first FOV measurement, and a first noise estimate to the machine learning model to generate the third log-distance depth map, wherein the first noise estimate represents an amount of noise added to the first log-distance depth map to generate the second log-distance depth map, and wherein generating the plurality of loss values based on the third log-distance depth map comprises (i) determining a weighted combination of (a) the first log-distance depth map and (b) the noise added to the first log-distance depth map to generate the second log-distance depth map, and (ii) determining pixel-wise differences between the weighted combination and the third log-distance depth map.

EEE 19 is the computer-implemented method of EEE 13, wherein training the machine learning model to predict log-distance metric depth maps for color images via an iterative diffusion inference process comprises training the machine learning model to predict log-distance metric depth maps for color images and associated noise inputs via the iterative diffusion inference process, wherein applying the first color image and the second log-distance depth map to the machine learning model to generate the third log-distance depth map comprises applying the first color image, the second log-distance depth map, and a first noise estimate to the machine learning model to generate the third log-distance depth map, wherein the first noise estimate represents an amount of noise added to the first log-distance depth map to generate the second log-distance depth map, and wherein generating the plurality of loss values based on the third log-distance depth map comprises (i) determining a weighted combination of (a) the first log-distance depth map and (b) the noise added to the first log-distance depth map to generate the second log-distance depth map, and (ii) determining pixel-wise differences between the weighted combination and the third log-distance depth map.

EEE 20 is the computer-implemented method of any of EEEs 13-19, further comprising determining the first log-distance depth map from a source distance depth map by: (i) determining a first intermediate depth map by dividing the source distance depth map by a minimum distance of the source distance depth map; (ii) determining a second intermediate depth map by determining a logarithm of the first intermediate depth map; (iii) determining a third intermediate depth map by dividing the second intermediate depth map by a logarithm of a ratio of a maximum distance of the source distance depth map and the minimum distance of the source distance depth map; and (iv) normalizing the third intermediate depth map to a finite range of values centered on zero.

EEE 21 is the computer-implemented method of any of EEEs 13-20, wherein training the machine learning model to predict log-distance metric depth maps for color images via the iterative diffusion inference process comprises using an augmented training dataset to train the machine learning model, wherein the augmented training dataset includes the first log-distance depth map and the first color image, and wherein the method further comprises augmenting a source training dataset to generate the augmented training dataset by at least one of cropping or un-cropping a source log-distance depth map and a source color image in at least one of a vertical direction or a horizontal direction to generate the first log-distance depth map and the first color image.

EEE 22 is the computer-implemented method of EEE 21, wherein un-cropping the source log-distance depth map and the source color image in at least one of a vertical direction or a horizontal direction comprises applying a generative machine learning model to un-crop the source log-distance depth map and the source color image.

EEE 23 is the computer-implemented method of EEE 21, wherein un-cropping the source log-distance depth map and the source color image in at least one of a vertical direction or a horizontal direction comprises padding the source log-distance depth map and the source color image with noise in at least one of the vertical direction or the horizontal direction.

EEE 24 is the computer-implemented method of any of EEEs 13-23, wherein training the machine learning model to predict log-distance metric depth maps for color images via the iterative diffusion inference process comprises using a training dataset to train the machine learning model, and wherein the training dataset contains examples of images and corresponding depth maps of indoor scenes and outdoor scenes such that the machine learning model is trained to predict log-distance metric depth maps for color images that represent indoor scenes or outdoor scenes.

EEE 25 is the computer-implemented method of any of EEEs 1-12, wherein training the machine learning model to predict depth maps for color images via the iterative diffusion inference process comprises training the machine learning model to predict metric depth maps for color images and associated field of view (FOV) measurements via the iterative diffusion inference process, wherein applying the first color image and the second depth map to the machine learning model to generate the third depth map comprises applying the first color image, a first FOV measurement, and the second depth map to the machine learning model to generate a third depth map, and wherein the first FOV measurement represents an angular field of view across at least one dimension of the first color image.

EEE 26 is the computer-implemented method of EEE 25, further comprising: (i) training a precursor machine learning model to predict metric depth maps for color images via an iterative diffusion inference process; and (ii) augmenting the trained precursor machine learning model to receive FOV measurements as inputs in addition to color images and depth maps, wherein training the machine learning model to predict metric depth maps comprises training the trained, augmented precursor machine learning model.

EEE 27 is the computer-implemented method of EEE 26, wherein augmenting the trained precursor machine learning model to receive FOV measurements as inputs in addition to color images and depth maps comprises: (i) adding a sinusoidal positional embedding of the FOV measurement input; and (ii) adding a linear projection of outputs of the sinusoidal positional embedding to one or more layers of the trained precursor machine learning model.

EEE 28 is the computer-implemented method of any of EEEs 25-27, wherein the first FOV measurement represents a tangent function of the angular field of view across at least one dimension of the first color image.

EEE 29 is the computer-implemented method of any of EEEs 25-28, wherein training the machine learning model to predict metric depth maps for color images via an iterative diffusion inference process comprises training the machine learning model to predict metric depth maps for color images and associated noise inputs via the iterative diffusion inference process, wherein applying the first color image and the second depth map to the machine learning model to generate the third depth map comprises applying the first color image, the second depth map, and a first noise estimate to the machine learning model to generate the third depth map, wherein the first noise estimate represents an amount of noise added to the first depth map to generate the second depth map, and wherein generating the plurality of loss values based on the third depth map comprises (i) determining a weighted combination of (a) the first depth map and (b) the noise added to the first depth map to generate the second depth map, and (ii) determining pixel-wise differences between the weighted combination and the third depth map.

EEE 30 is the computer-implemented method of any of EEEs 25-29, wherein training the machine learning model to predict metric depth maps for color images via the iterative diffusion inference process comprises using an augmented training dataset to train the machine learning model, wherein the augmented training dataset includes the first depth map and the first color image, and wherein the method further comprises augmenting a source training dataset to generate the augmented training dataset by at least one of cropping or un-cropping a source depth map and a source color image in at least one of a vertical direction or a horizontal direction to generate the first depth map and the first color image.

EEE 31 is the computer-implemented method of EEE 30, wherein un-cropping the source depth map and the source color image in at least one of a vertical direction or a horizontal direction comprises applying a generative machine learning model to un-crop the source depth map and the source color image.

EEE 32 is the computer-implemented method of EEE 30, wherein un-cropping the source depth map and the source color image in at least one of a vertical direction or a horizontal direction comprises padding the source depth map and the source color image with noise in at least one of the vertical direction or the horizontal direction.

EEE 33 is the computer-implemented method of any of EEEs 25-32, wherein training the machine learning model to predict metric depth maps for color images via the iterative diffusion inference process comprises using a training dataset to train the machine learning model, and wherein the training dataset contains examples of images and corresponding depth maps of indoor scenes and outdoor scenes such that the machine learning model is trained to predict metric depth maps for color images that represent indoor scenes or outdoor scenes.

EEE 34 is the computer-implemented method of any of EEEs 1-12, wherein training the machine learning model to predict depth maps for color images via the iterative diffusion inference process comprises training the machine learning model to predict metric depth maps for color images and associated noise inputs via the iterative diffusion inference process, wherein applying the first color image and the second depth map to the machine learning model to generate a third depth map comprises applying the first color image, a first noise estimate, and the second depth map to the machine learning model to generate a third depth map, wherein the first noise estimate represents an amount of noise added to the first depth map to generate the second depth map, and wherein the iterative diffusion inference process additionally comprises: determining a weighted combination of (i) the first depth map and (ii) the noise added to the first depth map to generate the second depth map, wherein generating the plurality of loss values comprises determining pixel-wise differences between the weighted combination and the third depth map to generate the plurality of loss values.

EEE 35 is the computer-implemented method of EEE 34, wherein training the machine learning model to predict metric depth maps for color images via the iterative diffusion inference process comprises using an augmented training dataset to train the machine learning model, wherein the augmented training dataset includes the first depth map and the first color image, and wherein the method further comprises augmenting a source training dataset to generate the augmented training dataset by at least one of cropping or un-cropping a source depth map and a source color image in at least one of a vertical direction or a horizontal direction to generate the first depth map and the first color image.

EEE 36 is the computer-implemented method of EEE 35, wherein un-cropping the source depth map and the source color image in at least one of a vertical direction or a horizontal direction comprises applying a generative machine learning model to un-crop the source depth map and the source color image.

EEE 37 is the computer-implemented method of EEE 35, wherein un-cropping the source depth map and the source color image in at least one of a vertical direction or a horizontal direction comprises padding the source depth map and the source color image with noise in at least one of the vertical direction or the horizontal direction.

EEE 38 is the computer-implemented method of any of EEEs 34-37, wherein training the machine learning model to predict metric depth maps for color images via the iterative diffusion inference process comprises using a training dataset to train the machine learning model, and wherein the training dataset contains examples of images and corresponding depth maps of indoor scenes and outdoor scenes such that the machine learning model is trained to predict metric depth maps for color images that represent indoor scenes or outdoor scenes.

EEE 39 is a computer-implemented method including using a machine learning model to predict a first target depth map for a target color image via an iterative diffusion inference process by, for a plurality of iterations: applying the target color image and a respective input depth map estimate to the machine learning model to generate a respective output depth map, wherein the input depth map of a first iteration of the plurality of iterations is a randomly or pseudo-randomly generated depth map of noise, wherein the input depth map for each iteration of the plurality of iterations other than the first iteration is the output depth map of an immediately preceding iteration with an amount of noise added thereto, and wherein the first target depth map is the output depth map of a final iteration of the plurality of iterations.

EEE 40 is the computer-implemented method of EEE 39, further comprising generating a novel view of a target scene depicted in the target color image by: (i) using the first target depth map and the target color image to render an alternative color image of the target scene, wherein the alternative color image includes holes representing aspects of the target scene that are occluded from view in the target color image; (ii) using the first target depth map to render an alternative depth map of the target scene as viewed from a perspective of the alternative color image, wherein the alternative depth map includes holes representing aspects of the target scene that are occluded from view in the first target depth map; (iii) filling in the holes of the alternative color image; and (iv) subsequent to filling in the holes of the alternative color image, using the machine learning model to fill in the holes of the alternative depth map via the iterative diffusion inference process by, for a plurality of iterations: applying the alternative color image and a respective input depth map estimate to generate a respective output depth map, wherein the input depth map of a first iteration of the plurality of iterations is the alternative depth map with an amount of noise added thereto, and wherein the input depth map for each iteration of the plurality of iterations other than the first iteration is the output depth map of an immediately preceding iteration with an amount of noise added thereto.

EEE 41 is the computer-implemented method of any of EEEs 39-40, wherein the machine learning model has a U-Net architecture.

EEE 42 is the computer-implemented method of any of EEEs 39-41, further comprising generating, for the target color image, a second target depth map for the target color image, by: (i) upsampling the first target depth map to generate an upsampled depth map; and (ii) using the machine learning model to predict a plurality of patches of the second target depth map for respective patches of the target color image via the iterative diffusion inference process, wherein using the machine learning model to predict a given patch of the second target depth map for a corresponding patch of the target color image via the iterative diffusion inference process comprises using, as the input depth map of a first iteration of the plurality of iterations of the process, a corresponding patch of the upsampled depth map.

EEE 43 is the computer-implemented method of any of EEEs 39-42, wherein the target color image represents an indoor scene, wherein the method additional comprises using the machine learning model to predict an additional target log-distance metric depth map for an additional target color image via the iterative diffusion inference process, and wherein the additional target color image represents an outdoor scene.

EEE 44 is the computer-implemented method of any of EEEs 39-43, wherein using the machine learning model to predict the first target depth map for the target color image via the iterative diffusion inference process comprises using the machine learning model to predict a first target log-distance metric depth map for the target color image via the iterative diffusion inference process, wherein the respective input depth map estimate is a respective input log-distance depth map, and wherein the respective output depth map is a respective output log-distance depth map.

EEE 45 is the computer-implemented method of EEE 44: wherein applying the target color image and the respective input log-distance depth map estimate to the machine learning model to generate the respective output log-distance depth map comprises applying the target color image, a target FOV measurement, and the respective input log-distance depth map estimate to the machine learning model to generate the respective output log-distance depth map, and wherein the target FOV measurement represents an angular field of view across at least one dimension of the target color image.

EEE 46 is the computer-implemented method of EEE 45, further comprising determining the target FOV measurement from the target image.

EEE 47 is the computer-implemented method of EEE 45 or 46, wherein the target FOV measurement represents a tangent function of the angular field of view across at least one dimension of the target color image.

EEE 48 is the computer-implemented method of any of EEEs 45-47, wherein applying the target color image, the target FOV measurement, and the respective input log-distance depth map estimate to the machine learning model to generate the respective output log-distance depth map comprises applying the target color image, the target FOV measurement, a respective noise estimate from a noise schedule, and the respective input log-distance depth map estimate to the machine learning model to generate the respective output log-distance depth map.

EEE 49 is the computer-implemented method of EEE 44, wherein applying the target color image and the respective input log-distance depth map estimate to the machine learning model to generate the respective output log-distance depth map comprises applying the target color image, a respective noise estimate from a noise schedule, and the respective input log-distance depth map estimate to the machine learning model to generate the respective output log-distance depth map.

EEE 50 is the computer-implemented method of any of EEEs 44-49, further comprising determining a linear metric depth map for the target color image by: (i) determining a first intermediate depth map by scaling and shifting the target log-distance metric depth map; (ii) determining a second intermediate depth map by exponentiating the first intermediate depth map; and (iii) scaling the second intermediate depth map.

EEE 51 is the computer-implemented method of any of EEEs 39-43, wherein applying the target color image and the respective input depth map estimate to the machine learning model to generate the respective output depth map comprises applying the target color image, a target FOV measurement, and the respective input depth map estimate to the machine learning model to generate the respective output depth map, and wherein the target FOV measurement represents an angular field of view across at least one dimension of the target color image.

EEE 52 is the computer-implemented method of EEE 51, further comprising determining the target FOV measurement from the target image.

EEE 53 is the computer-implemented method of any of EEEs 51 or 52, wherein the target FOV measurement represents a tangent function of the angular field of view across at least one dimension of the target color image.

EEE 54 is the computer-implemented method of any of EEEs 51-53, wherein applying the target color image, the target FOV measurement, and the respective input depth map estimate to the machine learning model to generate the respective output depth map comprises applying the target color image, the target FOV measurement, a respective noise estimate from a noise schedule, and the respective input depth map estimate to the machine learning model to generate the respective output-distance depth map.

EEE 55 is the computer-implemented method of any of EEEs 39-43, wherein applying the target color image and the respective input depth map estimate to the machine learning model to generate the respective output depth map comprises applying the target color image, a respective noise estimate from a noise schedule, and the respective input depth map estimate to the machine learning model to generate the respective output-distance depth map.

EEE 56 is the computer-implemented method of any of EEEs 39-55, wherein the machine learning model has been trained as in any of EEEs 1-38.

EEE 57 is a computer-implemented method including training a machine learning model to predict optical flow maps for pairs of color images via an iterative diffusion inference process, wherein training the machine learning model includes: (i) adding noise to a first optical flow map to generate a second optical flow map, wherein the first optical flow map represents optical flow from a first color image of a scene to a second color image of the scene; (ii) applying the first color image, the second color image and the second optical flow map to the machine learning model to generate a third optical flow map; (iii) based on the third optical flow map, generating a plurality of loss values; and (iv) updating the machine learning model based on the plurality of loss values.

EEE 58 is the computer-implemented method of EEE 57, further comprising: using the trained machine learning model to predict a first target optical flow map for a target pair of color images via the iterative diffusion inference process by, for a plurality of iterations: applying the target pair of color images and a respective input optical flow map estimate to the trained machine learning model to generate a respective output optical flow map, wherein the input optical flow map of a first iteration of the plurality of iterations is a randomly or pseudo-randomly generated optical flow map of noise, wherein the input optical flow map for each iteration of the plurality of iterations other than the first iteration is the output optical flow map of an immediately preceding iteration with an amount of noise added thereto, and wherein the first target optical flow map is the output optical flow map of a final iteration of the plurality of iterations.

EEE 59 is the computer-implemented method of any of EEEs 57-58, wherein generating the plurality of loss values comprises generating a plurality of L1 loss values between the third optical flow map and the first optical flow map or between the third optical flow map and the noise added to the first optical flow map to generate the second optical flow map.

EEE 60 is the computer-implemented method of any of EEEs 57-59, wherein the machine learning model has a U-Net architecture.

EEE 61 is the computer-implemented method of any of EEEs 57-60, wherein training the machine learning model to predict optical flow maps for pairs of color images via the iterative diffusion inference process comprises training the machine learning model to predict optical flow maps for pairs of color images and associated noise inputs via the iterative diffusion inference process, wherein applying the first color image, the second color image, and the second optical flow map to the machine learning model to generate a third optical flow map comprises applying the first color image, the second color image, a first noise estimate, and the second optical flow map to the machine learning model to generate a third optical flow map, wherein the first noise estimate represents an amount of noise added to the first optical flow map to generate the second optical flow map, and wherein the iterative diffusion inference process additionally comprises: determining a weighted combination of (i) the first optical flow map and (ii) the noise added to the first optical flow map to generate the second optical flow map, wherein generating the plurality of loss values comprises determining pixel-wise differences between the weighted combination and the third optical flow map to generate the plurality of loss values.

EEE 62 is a computer-implemented method comprising: using a machine learning model to predict a first target optical flow map for a target pair of color images via an iterative diffusion inference process by, for a plurality of iterations: applying the target pair of color images and a respective input optical flow map estimate to the machine learning model to generate a respective output optical flow map, wherein the input optical flow map of a first iteration of the plurality of iterations is a randomly or pseudo-randomly generated optical flow map of noise, wherein the input optical flow map for each iteration of the plurality of iterations other than the first iteration is the output optical flow map of an immediately preceding iteration with an amount of noise added thereto, and wherein the first target optical flow map is the output optical flow map of a final iteration of the plurality of iterations.

EEE 63 is the computer-implemented method of EEE 62, wherein the machine learning model has a U-Net architecture.

EEE 64 is the computer-implemented method of any of EEEs 62-63, further comprising generating, for the target pair of color images, a second target optical flow map for the target pair of color images, by: (i) upsampling the first target optical flow map to generate an upsampled optical flow map; and (ii) using the machine learning model to predict a plurality of patches of the second target optical flow map for respective patches of the target pair of color images via the iterative diffusion inference process, wherein using the machine learning model to predict a given patch of the second target optical flow map for a corresponding patch of the target pair of color images via the iterative diffusion inference process comprises using, as the input optical flow map of a first iteration of the plurality of iterations of the process, a corresponding patch of the upsampled optical flow map.

EEE 65 is the computer-implemented method of any of EEEs 62-64, wherein applying the target pair of color images and the respective input optical flow map estimate to the machine learning model to generate the respective output optical flow map comprises applying the target pair of color images, a respective noise estimate from a noise schedule, and the respective input optical flow map estimate to the machine learning model to generate the respective output optical flow map.

EEE 66 is the computer-implemented method of any of EEEs 62-65, wherein the machine learning model has been trained as in any of EEEs 57-61.

EEE 67 is a computing device comprising: one or more processors, wherein the one or more processors are configured to perform the method of any preceding EEE.

EEE 68 is an article of manufacture including a non-transitory computer-readable medium, having stored thereon program instructions that, upon execution by a computing device, cause the computing device to perform operations to effect the method of any of EEEs 1-66

1. A computer-implemented method comprising:
training a machine learning model to predict depth maps for color images via an iterative diffusion inference process, wherein training the machine learning model comprises:
adding noise to a first depth map to generate a second depth map, wherein the first depth map represents depth across a first scene depicted in a first color image;
applying the first color image and the second depth map to the machine learning model to generate a third depth map;
based on the third depth map, generating a plurality of loss values; and
updating the machine learning model based on the plurality of loss values.

2-3. (canceled)

4. The computer-implemented method of claim 1, wherein generating the plurality of loss values comprises generating a plurality of L1 loss values between the third depth map and the first depth map or between the third depth map and the noise added to the first depth map to generate the second depth map.

5. The computer-implemented method of claim 1, further comprising:
training a precursor machine learning model to predict restored color images for degraded color images via an iterative diffusion inference process, wherein training the precursor machine learning model comprises:
adding noise to a first source color image to generate a second source color image;
applying the second source color image and a third source color image to the precursor machine learning model to generate a fourth source color image, wherein the third source color image is a degraded version of the first source color image that has been degraded by at least one of: (i) being cropped, (ii) being decolorized, (iii) having had image compression artifacts added thereto, or (iv) having had one or more regions of missing pixels added thereto; and
updating the precursor machine learning model based on a plurality of loss values generated based on differences between the fourth source color image and the first source color image; and
modifying the precursor machine learning model to receive an input color image and an input depth map and to generate therefrom an output depth map based on the input depth map and conditioned on the input color image, wherein training the machine learning model to predict depth maps for color images via the iterative diffusion inference process comprises using the modified precursor machine learning model as an initial state for the machine learning model.

6-7. (canceled)

8. The computer-implemented method of claim 1, wherein training the machine learning model further comprises:
prior to adding noise to the first depth map to generate the second depth map, filling in at least one hole in the first depth map.

9. (canceled)

10. The computer-implemented method of claim 8, wherein filling in at least one hole in the first depth map comprises (i) identifying, based on the first color image, a region of the first depth map that represents a sky and (ii) filling in pixels of the region of the first depth map that represents the sky with a specified depth value.

11-12. (canceled)

13. The computer-implemented method of claim 1, wherein training the machine learning model to predict depth maps for color images via the iterative diffusion inference process comprises:
training the machine learning model to predict log-distance metric depth maps for color images via the iterative diffusion inference process, wherein the first depth map is a first log-distance depth map, wherein the second depth map is a second log-distance depth map, wherein the first log-distance depth map represents the logarithm of depth across the first scene depicted in the first color image, and wherein the third depth map is a third log-distance depth map.

14-19. (canceled)

20. The computer-implemented method of claim 13, further comprising determining the first log-distance depth map from a source distance depth map by:
determining a first intermediate depth map by dividing the source distance depth map by a minimum distance of the source distance depth map;
determining a second intermediate depth map by determining a logarithm of the first intermediate depth map;
determining a third intermediate depth map by dividing the second intermediate depth map by a logarithm of a ratio of a maximum distance of the source distance depth map and the minimum distance of the source distance depth map; and
normalizing the third intermediate depth map to a finite range of values centered on zero.

21-24. (canceled)

25. The computer-implemented method of claim 1, wherein training the machine learning model to predict depth maps for color images via the iterative diffusion inference process comprises training the machine learning model to predict metric depth maps for color images and associated field of view (FOV) measurements via the iterative diffusion inference process, wherein applying the first color image and the second depth map to the machine learning model to generate the third depth map comprises applying the first color image, a first FOV measurement, and the second depth map to the machine learning model to generate a third depth map, and wherein the first FOV measurement represents an angular field of view across at least one dimension of the first color image.

26. The computer-implemented method of claim 25, further comprising:
training a precursor machine learning model to predict metric depth maps for color images via an iterative diffusion inference process; and
augmenting the trained precursor machine learning model to receive FOV measurements as inputs in addition to color images and depth maps, wherein training the machine learning model to predict metric depth maps comprises training the trained, augmented precursor machine learning model.

27. The computer-implemented method of claim 26, wherein augmenting the trained precursor machine learning model to receive FOV measurements as inputs in addition to color images and depth maps comprises:
adding a sinusoidal positional embedding of the FOV measurement input; and
adding a linear projection of outputs of the sinusoidal positional embedding to one or more layers of the trained precursor machine learning model.

28. The computer-implemented method of claim 25, wherein the first FOV measurement represents a tangent function of the angular field of view across at least one dimension of the first color image.

29. (canceled)

30. The computer-implemented method of claim 25, wherein training the machine learning model to predict metric depth maps for color images via the iterative diffusion inference process comprises using an augmented training dataset to train the machine learning model, wherein the augmented training dataset includes the first depth map and the first color image, and wherein the method further comprises augmenting a source training dataset to generate the augmented training dataset by at least one of cropping or un-cropping a source depth map and a source color image in at least one of a vertical direction or a horizontal direction to generate the first depth map and the first color image.

31. (canceled)

32. The computer-implemented method of claim 30, wherein un-cropping the source depth map and the source color image in at least one of a vertical direction or a horizontal direction comprises padding the source depth map and the source color image with noise in at least one of the vertical direction or the horizontal direction.

33. (canceled)

34. The computer-implemented method of claim 1, wherein training the machine learning model to predict depth maps for color images via the iterative diffusion inference process comprises training the machine learning model to predict metric depth maps for color images and associated noise inputs via the iterative diffusion inference process, wherein applying the first color image and the second depth map to the machine learning model to generate a third depth map comprises applying the first color image, a first noise estimate, and the second depth map to the machine learning model to generate a third depth map, wherein the first noise estimate represents an amount of noise added to the first depth map to generate the second depth map, and wherein the iterative diffusion inference process additionally comprises:
determining a weighted combination of (i) the first depth map and (ii) the noise added to the first depth map to generate the second depth map, wherein generating the plurality of loss values comprises determining pixel-wise differences between the weighted combination and the third depth map to generate the plurality of loss values.

35-38. (canceled)

39. A computer-implemented method comprising:
using a machine learning model to predict a first target depth map for a target color image via an iterative diffusion inference process by, for a plurality of iterations:
applying the target color image and a respective input depth map estimate to the machine learning model to generate a respective output depth map, wherein the input depth map of a first iteration of the plurality of iterations is a randomly or pseudo-randomly generated depth map of noise, wherein the input depth map for each iteration of the plurality of iterations other than the first iteration is the output depth map of an immediately preceding iteration with an amount of noise added thereto, and wherein the first target depth map is the output depth map of a final iteration of the plurality of iterations.

40. The computer-implemented method of claim 39, further comprising generating a novel view of a target scene depicted in the target color image by:
using the first target depth map and the target color image to render an alternative color image of the target scene, wherein the alternative color image includes holes representing aspects of the target scene that are occluded from view in the target color image;
using the first target depth map to render an alternative depth map of the target scene as viewed from a perspective of the alternative color image, wherein the alternative depth map includes holes representing aspects of the target scene that are occluded from view in the first target depth map;
filling in the holes of the alternative color image; and
subsequent to filling in the holes of the alternative color image, using the machine learning model to fill in the holes of the alternative depth map via the iterative diffusion inference process by, for a plurality of iterations:
applying the alternative color image and a respective input depth map estimate to generate a respective output depth map, wherein the input depth map of a first iteration of the plurality of iterations is the alternative depth map with an amount of noise added thereto, and wherein the input depth map for each iteration of the plurality of iterations other than the first iteration is the output depth map of an immediately preceding iteration with an amount of noise added thereto.

41. (canceled)

42. The computer-implemented method of claim 39, further comprising generating, for the target color image, a second target depth map for the target color image, by:
upsampling the first target depth map to generate an upsampled depth map; and
using the machine learning model to predict a plurality of patches of the second target depth map for respective patches of the target color image via the iterative diffusion inference process, wherein using the machine learning model to predict a given patch of the second target depth map for a corresponding patch of the target color image via the iterative diffusion inference process comprises using, as the input depth map of a first iteration of the plurality of iterations of the process, a corresponding patch of the upsampled depth map.

43. (canceled)

44. The computer-implemented method of claim 39, wherein using the machine learning model to predict the first target depth map for the target color image via the iterative diffusion inference process comprises using the machine learning model to predict a first target log-distance metric depth map for the target color image via the iterative diffusion inference process, wherein the respective input depth map estimate is a respective input log-distance depth map, and wherein the respective output depth map is a respective output log-distance depth map.

45-49. (canceled)

50. The computer-implemented method of claim 44, further comprising determining a linear metric depth map for the target color image by:
determining a first intermediate depth map by scaling and shifting the target log-distance metric depth map;
determining a second intermediate depth map by exponentiating the first intermediate depth map; and
scaling the second intermediate depth map.

51. The computer-implemented method of claim 39, wherein applying the target color image and the respective input depth map estimate to the machine learning model to generate the respective output depth map comprises applying the target color image, a target FOV measurement, and the respective input depth map estimate to the machine learning model to generate the respective output depth map, and wherein the target FOV measurement represents an angular field of view across at least one dimension of the target color image.

52-68. (canceled)
